(19) United States
(12) Patent Application Publication
(10) Pub. No.: US 2025/0376392 A1
(43) Pub. Date: Dec. 11, 2025

(54) Devices for Long-Term Controlled Release of Payloads in Aqueous Environments

(71) Applicant: The University of Toledo, Toledo, OH (US)

(72) Inventors: Yakov Lapitsky, Toledo, OH (US); Umberto Alencar Kober, Toledo, OH (US); Youngwoo Seo, Toledo, OH (US)

(73) Assignee: The University of Toledo, Toledo, OH (US)

(21) Appl. No.: 19/231,921

(22) Filed: Jun. 9, 2025

Related U.S. Application Data
(60) Provisional application No. 63/658,111, filed on Jun. 10, 2024.

(51) Int. Cl. C02F 1/68; B63B 22/24; C02F 1/50; C02F 103/00

(52) U.S. Cl. CPC C02F 1/685; B63B 22/24; C02F 1/50; C02F 2103/007; C02F 2201/002; C02F 2303/20

(57) ABSTRACT

A buoy for the sustained release of a payload, such as an algaecide, into an aqueous environment is described. For the buoy to release the payload into the aqueous environment, the payload diffuses through a hydrogel fixedly housed within the buoy.

### RELATED APPLICATIONS

This application claims priority to United States Provisional Application No. 63/658, 111 filed under 35 U.S.C. § 111(b) on Jun. 10, 2024, the disclosure of which is incorporated herein by reference in its entirety.

### STATEMENT REGARDING FEDERALLY SPONSORED RESEARCH

This invention was made with government support under Grant Number W912HZ2220045 awarded by the U.S. Army Corps of Engineers. The government has certain rights in this invention.

### BACKGROUND

Cyanobacterial harmful algal blooms (CHABs) represent an increasing challenge from both ecological and economic perspectives. These phenomena, often intensified by factors such as nutrient pollution and climate change, not only destabilize aquatic ecosystems but also pose significant risks to public health and water resources. These blooms can lead to hypoxic conditions, loss of biodiversity, and production of harmful toxins, adversely affecting both marine and freshwater systems. From the human health and economic perspectives, CHABs also adversely affect sectors such as water treatment, fishing, and tourism. In drinking water treatment plants (DWTPs), for instance, the proliferation of cyanobacteria can result in high concentrations of toxins such as microcystins, cylindrospermopsins, and saxitoxins. Moreover, non-toxic metabolites like 2-methylisoborneol and geosmin can further compromise water quality altering its taste and odor.

To overcome this challenge, significant resources are being devoted to treating lakes, ponds, and reservoirs with algicidal chemicals. These include copper and aluminum salts, as well as reactive oxygen species (mainly peroxides). Algaecide is often applied all at once, without a sustained release. However, due to the rapid decays in the available algaecide concentrations upon their application, such algicidal treatments often fail to achieve a long-term effect and require frequent reapplication. Not only is this expensive, but the frequent reapplication increases chemical exposure to users. Furthermore, being corrosive, some widely used algaecides (e.g., H₂O₂) demand special precautions during their transportation, storage, and use and can increase risks to operators and the environment, as well as escalate their application costs.

One approach to addressing the problems with repeated algaecide application is to use sustained release technologies (i.e., technologies allowing the encapsulation and slow release of the algaecide). Besides extending the treatment duration, this approach can both limit operator exposure to the algaecide and reduce aquatic toxicity by preventing frequent spikes in the algaecide concentrations. The commercial sustained algaecide release technologies developed to date include coated copper sulfate (which releases algaecide into the algae-rich top of the water column over several hours and, in the case of one type of polyurethane- or wax-coated copper sulfate granules, enables algaecide release for over 10 weeks). These coated granules provide better performance than their uncoated counterparts, but are a lot more expensive.

Other sustained algaecide release systems include slowly dissolving calcium peroxide granules. These granules slowly dissolve for as long as several weeks, simultaneously killing algae through oxidative stress and also (through insoluble calcium phosphate salt formation) removing phosphorous, which is a vital nutrient for algae growth, from the environment. There have also been reports of the encapsulation of poorly soluble organic algaecides such as luteolin, artemisinin, and linoleic acid, as well as calcium peroxide pellets in chitosan-coated calcium alginate gel beads and in chitosan- and/or alginate-based micro- or submicron-scale particles. Besides these polysaccharide-based carriers, specialized synthetic polymer gels have been developed, which control algaecide release over times ranging from hours to days, depending on the aqueous nitrite concentration, which serves as a marker for CHAB intensity. This approach has the advantage of enabling stimulus-responsive algaecide release that is targeted to specific water conditions but which (1) requires a highly specialized polymer, which undermines its economic viability and scalability, and (2) limits the release process to just a few days. Furthermore, all these gels, granules, and micro- or submicron-scale particles can be displaced from their application location by water currents, wind, or (when they are not imparted with the floating functionality) sedimentation, and (3) the polymers used to form the capsules or granules are not removed from the water body, and consequently, can leave foreign materials in the environment.

There remains a need for new and improved devices, compositions, and methods for preventing harmful algal blooms and otherwise controlling algae.

### SUMMARY

Provided is a buoy for delivering a payload, the buoy comprising a buoyant structure comprising one or more enclosure components in water-tight communication, the enclosure components including a first arm and a central member defining a reservoir; and a gel disk assembly disposed within the first arm, wherein the gel disk assembly comprises a hydrogel; wherein a payload within the reservoir is capable of exiting the buoy upon diffusion of the payload through the hydrogel.

In certain embodiments, the gel disk assembly includes a mesh configured to retain the hydrogel in position in the gel disk assembly. In particular embodiments, the mesh is uncoated, coated with a dual N,N′, methylenebisacrylamide (MBA)- and Al³⁺-crosslinked polyacrylic acid (PAA) (dual-crosslinked PAA-Al³⁺) hydrogel coating, or coated with a polysulfobetaine methacrylate (PSBMA) hydrogel coating. In particular embodiments, the gel disk assembly comprises a plastic ring housing the hydrogel, and the mesh is adhered to the plastic ring. In particular embodiments, the plastic ring includes grooves configured to hold the hydrogel in place within the ring.

In certain embodiments, the gel disk assembly includes a perforated solid sheet or film configured to retain the hydrogel in position in the gel disk assembly.

In certain embodiments, the hydrogel comprises a PAA.

In certain embodiments, the buoy further comprises a second arm in water-tight communication with the central member, the second arm comprising a second gel disk assembly.

In certain embodiments, the enclosure components comprise a buoyant plastic material.

In certain embodiments, the enclosure components comprise low-density polyethylene (LDPE), high-density polyethylene (HDPE), polypropylene, polystyrene, polypropylene copolymer, or combinations thereof. In certain embodiments, the enclosure components comprise polyvinyl chloride (PVC). In certain embodiments, the enclosure components comprise a foamed PVC.

In certain embodiments, the buoy further comprises a third arm in water-tight communication with the central member, wherein the reservoir extends into the third arm. In particular embodiments, the third arm is configured to be disposed below a water level of an aqueous environment when the reservoir contains a payload having a density greater than water, and wherein the third arm is configured to float at the water level when the reservoir is substantially free of the payload.

In certain embodiments, the first arm defines a first exit, and the reservoir is configured to hold a payload which can only pass through the first exit by diffusing through the hydrogel.

In certain embodiments, the buoy further comprises a floatation aid on the first arm to aid in buoyancy. In particular embodiments, the floatation aid is a ring surrounding the first arm. However, in alternative embodiments, a floatation aid can have any suitable structure. In certain embodiments, the buoy further comprises a second arm connected to the central member, and the second arm further comprises a second floatation aid. In particular embodiments, the second floatation aid is a second ring surrounding the second arm.

In certain embodiments, the buoy further comprises a bracing structure within the first arm, the bracing structure being configured to protect the gel disk assembly from contact by physical objects entering the first arm from an aqueous environment.

In certain embodiments, the buoy further comprises a pressure equalizer tube configured to vent a gas from the central member to an external environment.

In certain embodiments, the buoy further comprises a removable cap. In particular embodiments, the buoy further comprises a pressure equalizer tube configured to vent a gas from the central member to an external environment. In particular embodiments, the pressure equalizer tube runs through or is attached to the removable cap. In particular embodiments, the pressure equalizer tube runs through or is attached to the first arm or the central member. In particular embodiments, the buoy further comprises a sampling collection port in the removable cap.

In certain embodiments, the hydrogel is formed from a free-radical polymerization of an aqueous solution containing acrylic acid (AA), MBA, AlCl₃, and ammonium persulfate (APS).

In certain embodiments, the hydrogel is in the form of a cylindrical disk within the gel disk assembly. In certain embodiments, the gel disk assembly does not have a circular cross section.

Further provided is a hydrogel composition comprising a hydrogel formed from a free-radical polymerization of an aqueous solution containing about 1 M AA, about 4 wt % MBA, about 1 wt % AlCl₃, and about 0.4 wt % APS.

Further provided is a buoy for the sustained release of a payload, the buoy comprising a buoyant structure including a hydrogel structure, a reservoir, and an opening, wherein the reservoir is configured to hold a payload that can only reach the opening by diffusing through the hydrogel structure.

In certain embodiments, the hydrogel structure comprises a gel disk assembly including a ring housing, a hydrogel held in place by a mesh, perforated or porous film, or perforated or porous sheet.

In certain embodiments, the reservoir comprises a bottle, jar, jug, or other carboy and the hydrogel structure comprises a gel-bearing cap replacement including a coupling cone and a gel compartment.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1: Perspective view of a non-limiting example buoy in accordance with the present disclosure.

FIG. 2: Perspective view of another non-limiting example buoy in accordance with the present disclosure.

FIG. 3: Perspective view of another non-limiting example buoy in accordance with the present disclosure.

FIG. 4: Perspective view of another non-limiting example buoy in accordance with the present disclosure.

FIGS. 5A-5B: Illustrations of a buoy floating in a first manner with a reservoir full of payload (FIG. 5A) and floating in a second manner with an empty reservoir (i.e., no payload remaining) (FIG. 5B).

FIGS. 6A-6C: Algicide-releasing device schemes (not drawn to scale) showing: a small-scale device with an internal volume of 20 mL, which releases algaecide through a single gel disk (FIG. 6A), and medium- and large-scale devices (FIG. 6B), with internal volumes of 145 mL and 4500 mL, respectively, which release algaecide through two identical gel disks. The enlargement on the right side of FIG. 6B shows the design of the compartment housing the gels (in devices of all sizes) with both a frontal and cross-sectional view of the disk to illustrate the internal assembly, which includes the support mesh, the grooves on the inner wall of the PVC disk to grip the gel, and the release-rate-controlling gel layer. FIG. 6C shows pictures of the devices: (i) small, (ii) medium, (iii) large, with their respective mesh-covered PVC gel compartments (½, 1, and, 4″ in diameter).

FIG. 7: Experimental setup for the assessment of algicidal activity in Lake Erie water. The three 1 L beakers on the left contain small buoys loaded with Oxymycin™ P5, while the three on the right are the negative control samples.

FIGS. 8A-8F: Representative photographs of the synthesized gels (containing 4 wt % MBA) after being washed in deionized water (FIG. 8A), and evolutions in normalized gel weights on immersion in deionized water (FIG. 8B) and full-strength Oxymycin™ P5 (FIG. 8C) (mean±SD). FIG. 8D shows the stress-strain curves and FIG. 8E shows the compressive moduli of gels synthesized (using 4 wt % MBA) either with or without AlCl₃, and FIG. 8F shows the equilibrium H₂O₂ partitioning between the gel and surrounding solution (mean±SD). The lines in FIGS. 8B, 8C are guides to the eye while that in FIG. 8F is the linear regression to the data (R²=0.9879), whose slope (1.08±0.06) reveals the distribution coefficient for the H₂O₂. The images in FIG. 8D show how gels synthesized with and without AlCl₃ respond to compression and (in the case of gels formed in the presence of AlCl₃) their shape memory properties.

FIGS. 9A-9D: Release profiles achieved using small buoys loaded with full-strength Oxymycin™ P5 and equipped with either 0.5, 1.0, or 2.0-cm-thick gel disks (FIG. 9A), small buoys equipped with 1.0-cm-thick gel disks and loaded with either diluted (1 or 5 wt % H₂O₂) or full-strength (27.5% H₂O₂) Oxymycin™ P5 (FIG. 9B), small and medium buoys equipped with 1.0-cm-thick gel disks loaded with 27.5% Oxymycin™ P5, and large buoys with 1.0-cm-thick gel disks loaded with 5% Oxymycin™ P5 (FIG. 9C), and FIG. 9D shows all release profiles from FIGS. 9A-9C scaled to the initial H₂O₂ concentrations and characteristic release process time, (mean±SD). All closed symbols represent data obtained from the external H₂O₂ concentration in the release medium, while open symbols in FIG. 9B are data points obtained from measurements of the internal H₂O₂ concentration inside the buoys. The shaded regions, which (when thin) sometimes overlap with the dashed lines, show the release behavior predicted via Eqs. 6 and 7 based on the H-value from the examples herein and the (1.5-2.0×10⁻⁵ cm²/s) D-values reported in the literature. Conversely, the dashed lines in FIGS. 9A-9C are the model release profiles obtained using the DH product (obtained by fitting all the combined M(t)/M_{∞} data sets in FIG. 9D replotted versus at/V_{A}L to Eq. 6) as the sole adjustable parameter. The solid line in FIG. 9D is the resulting fitted master curve, which describes all tested release profiles and was obtained by neglecting the variable. albeit very small, lag time (tₗ).

FIGS. 10A-10D: Microbial growth and peroxide release in buoy experiments: a photograph showing the microbial growth on the mesh-covered gel disk of a small buoy that initially contained 1 wt % H₂O₂ after 19 days of release time (FIG. 10A), evolutions in the external H₂O₂ concentration for the same buoy showing a precipitous H₂O₂ concentration drop after the appearance of this microbial growth (FIG. 10B), a comparison of the release profiles from small and medium buoys initially containing 27.5 wt % H₂O₂ measured based on internal and external concentration measurements under conditions where this microbial growth was minimized (FIG. 10C), and temporal evolutions in the internal H₂O₂ concentrations within the large buoys (FIG. 10D) (mean±SD).

FIGS. 11A-11D: Evolutions in algal Chl-a concentrations in the microcosm algicidal activity experiment comparing untreated (control) lake water with that treated with the small algaecide-releasing buoys (FIG. 11A), H₂O₂ concentration in the same lake water upon a single-shot addition of diluted Oxymycin™ P5 fitted to the first-order decay equation (R²=0.9947) as shown by the solid curve (FIG. 11B), predicted and experimentally measured H₂O₂ concentration within the buoy-treated lake water (FIG. 11C), and a representative photograph of the biofouling on the exteriors of the mesh-covered gel disks after 14 days (FIG. 11D). All data points are mean±SD, while the asterisks in FIG. 11A denote the levels of statistical significance: (*)p<0.05, (**)p<0.01, and (***)p<0.001.

FIG. 12: Predicted and experimentally measured H₂O₂ (diluted Oxymycin™ P5) within the buoys used in the microcosm algicidal activity analysis (mean±SD). The model prediction was obtained based on Eq. 6 and a DH product (obtained from the data in FIGS. 9A-9D and FIG. 17) of 1.90×10⁻⁵ cm²/s. The close agreement between the experimentally determined internal H₂O₂ concentrations within the buoys used in the algicidal activity experiment and the model predictions confirms that the release kinetics during this experiment matched those predicted from the release data in FIGS. 9A-9D.

FIGS. 13A-13B: Effect of internal solution density on the full-scale (large) buoy orientation illustrated through digital photography (FIG. 13A) and measurement of the buoy angle with respect to the water line (mean±SD) (FIG. 13B). The images and data points of the buoy orientations at various internal solution densities correspond to (i) full-strength Oxymycin™ P5 and Oxymycin™ P5 concentrations remaining in the buoys when (ii) 40%, (iii) 60%. (iv) 70%. (v) 87%, and (vi) 100% algaecide release is achieved. The line in the plot is a guide to the eye.

FIGS. 14A-14B: Evolution of normalized gel weights for gels (synthesized using 4 wt % MBA) with and without 1 wt % AlCl; on immersion in deionized water (FIG. 14A) and full-strength Oxymycin™ P5 (FIG. 14B) (mean±SD).

FIGS. 15A-15B: Repeated peroxide release from small gel buoys reloaded without replacing the gel disks shown in the form of release profiles (FIG. 15A) and a parity plot comparing the amounts of H₂O₂ released at each time point upon reloading the buoys for the second and third time to the amounts released (at corresponding time points) the first time the buoy was loaded (FIG. 15B) (mean±SD). The shaded region in FIG. 15A shows the release behavior predicted via Eqs. 6 and 7 based on the H-value from the examples herein and the (1.5-2.0×10⁻⁵ cm²/s) D-values reported in the literature. Conversely, the dashed line in the same plot is the model release profile obtained using the DH product (obtained by fitting all the combined M(t)/M_{∞} data sets in FIG. 9D replotted versus at/VAL to Eq. 6) as the sole adjustable parameter, and the dashed line in FIG. 15B is the parity line (on which all data should fall if the release profiles obtained upon reloading the buoys are identical to those achieved upon their first use).

FIG. 16: Short-term experimental release data obtained for the small buoys constructed with 0.5-2.0-cm-thick gel disks (mean±SD). The shaded regions show the release behavior predicted via Eqs. 6 and 7 based on the H-value from the examples herein and the (1.5-2.0×10⁻⁵ cm²/s) D-values reported in the literature. Conversely, the dashed lines are the model release profiles obtained using the DH product (obtained by fitting all the combined M(t)/M_{∞} data sets in FIG. 9D replotted versus at/VAL to Eq. 6) as the sole adjustable parameter. The theoretical tₗ is shown by the points where the model curves intercept the horizontal axis.

FIG. 17: All release profiles from FIGS. 9A-9C scaled to the initial H₂O₂ concentrations, volumes, and gel disk thicknesses and external surface areas (mean±SD). The solid line is the master curve obtained by fitting all the scaled experimental release profile data points to Eq. 6 (while neglecting the variable, albeit very small, lag time, tₗ). This fitting (which used the DH product as the sole adjustable parameter) gave a DH-value of (1.90±0.04)×10⁻⁵ cm²/s.

FIG. 18: Digital photograph of the mesh used to cover the gels in the examples herein.

FIG. 19A-19B: These figures depict an algicide-releasing device scheme. FIG. 19A shows a practical buoy constructed from a jug with an internal volume of 2.75 L, measuring 10″ in length and 6″ in diameter. The jug-based buoy is designed to release algaecide through a gel-bearing cap replacement. FIGS. 19B-19I detail the design of the gel-bearing cap replacement, which is configured to screw onto the jug and house a hydrogel structure. The gel-bearing cap replacement includes a coupling cone and a gel compartment. FIG. 19B-19E further illustrate the coupling cone with elevation (FIG. 19B), cross-sectional (FIG. 19C), plain top (FIG. 19D), and perspective (FIG. 19E) views. FIG. 19F-19I further illustrates the gel compartment with elevation (FIG. 19F), cross-sectional (FIG. 19G), plain top (FIG. 19H), and perspective (FIG. 19I) views. While example dimensions are shown, alternative embodiments of a gel-bearing cap replacement can have any suitable dimensions.

FIG. 20: Digital photographs of a buoyancy test, illustrating the buoyancy of the jug-based buoy when its reservoir is fully loaded with a 1.16 g/mL NaCl payload solution and placed in a 47-gal drum containing 170 L of tap water.

FIG. 21: Release profile achieved using the jug-based buoy loaded with 7 wt % H₂O₂ solution (diluted Oxymycin™ P5) and equipped with a 1.2-cm-thick gel disk with an approximate external surface of 60-cm² (mean±SD). The closed symbols represent data from the external H₂O₂ concentration in the release medium, while the solid line depicts the release behavior predicted by Eqs. 6 and 7, based on the H-value from the examples herein and the D-values (1.5-2.0 ×10⁵ cm²/s) reported in the literature.

FIG. 22: Digital photographs of gel disc surfaces showing the evolution of biofouling before and after a 63-day incubation period in water. The leftmost gel disc was uncoated, the center gel disc mesh was coated with dual-crosslinked PAA-Al³⁺, and the rightmost gel disc mesh was coated with PSBMA.

FIG. 23: Optical coherence tomography (OCT) images of gel disc surfaces, illustrating the evolution of biofouling before and after 63 days of incubation in water. The leftmost gel disc was uncoated. the center gel disc mesh was coated with dual-crosslinked PAA-Al³⁺, and the rightmost gel disc mesh was coated with PSBMA. The arrows point to regions of accumulated biofouling.

FIG. 24: Adenosine triphosphate (ATP) analysis of microbial contamination on the gel disc surfaces after 63 days of incubation in water. The analysis was conducted using a QG21W™ATP assay kit (LuminUltra, Fredericton, NB, Canada), with results expressed as mean±SD. Before analysis, the surface-attached biomass was detached and dispersed in phosphate-buffered saline through sonication.

FIG. 25A-25D: Present the analysis of H₂O₂ release in submerged buoys. FIG. 25A illustrates the experimental setup for the assessment of H₂O₂ release in submerged buoys (performed using small-scale buoys with internal volumes of 20 mL). The water columns shown are 1.8 m in total length. with an enlargement on the left side of FIG. 25A depicting the buoy submerged at 1.5 m below the water surface. FIG. 25B compares the experimentally measured internal H₂O₂ concentration evolution within the buoys immersed 1.5 m underwater (represented by square data points) with model predictions according to Eqs. 3 and 5 (represented by a dashed line). FIG. 25C shows a comparison between the predicted (solid line) and experimentally measured (plotted points) water infiltration distance into the pressure equalizer tube when the buoys, with varying headspace volumes of 1 to 6 mL, were loaded with water. FIG. 25D compares the infiltration distance in buoys with a standard 4 mL headspace loaded with water (square data points) to those loaded with H₂O₂-based algaecide (circular data points), presented as mean±SD.

### DETAILED DESCRIPTION

Throughout this disclosure, various publications, patents, and published patent specifications are referenced by an identifying citation. The disclosures of these publications, patents, and published patent specifications are hereby incorporated by reference into the present disclosure in their entirety to more fully describe the state of the art to which this invention pertains.

Provided are reusable buoy-like devices (referred to herein as buoys) for the sustained release of algaecides or other actives, such as pesticides, in an aqueous environment. The buoys are useful for the long-term treatment of CHABs, among other things. The buoys permit the release of water-soluble algaecides over timescales that can exceed 1 month and can be precisely tailored by varying the surface area and thickness of the gel-based algaecide diffusion barriers (through which the algaecide is released), as well as their internal algaecide solution volume. Moreover, the algaecide dosing can be adjusted by tuning the initial algaecide concentration in the buoys. Besides their sustained release functionality, the buoys (1) can be immobilized or localized to release the algaecides at their target application sites (e.g., near the surface or off the shore), and (2) can be designed to flip upon releasing their payloads, to alert their users that the buoys should be reloaded. These reusable, algaecide-releasing buoys can overcome challenges in achieving sustained and targeted algacidal effects in lakes, ponds, and reservoirs, and minimize the need for repeated and costly algaecide treatment. Additionally, the sustained-release technology can be applied beyond CHAB control, for example for pest control in rice fields or for sustained disinfection.

As noted above, the buoys can provide sustained release of algaecide over periods exceeding 30 days, where the release rate is controlled by a hydrogel-based diffusion barrier. In addition to achieving highly sustained release, the buoys—unlike the current, single-use algaecide encapsulation/release technologies—are: (1) reusable, which could reduce the application costs of sustained algaecide release technologies, (2) capable of being immobilized/tethered to target application sites (e.g., near the surface or the shore), which could further reduce the cost and ecological footprint of the algacidal treatment, and (3) removable from the water after their use, which could minimize the amount of encapsulant material left in the water once the algaecide is released.

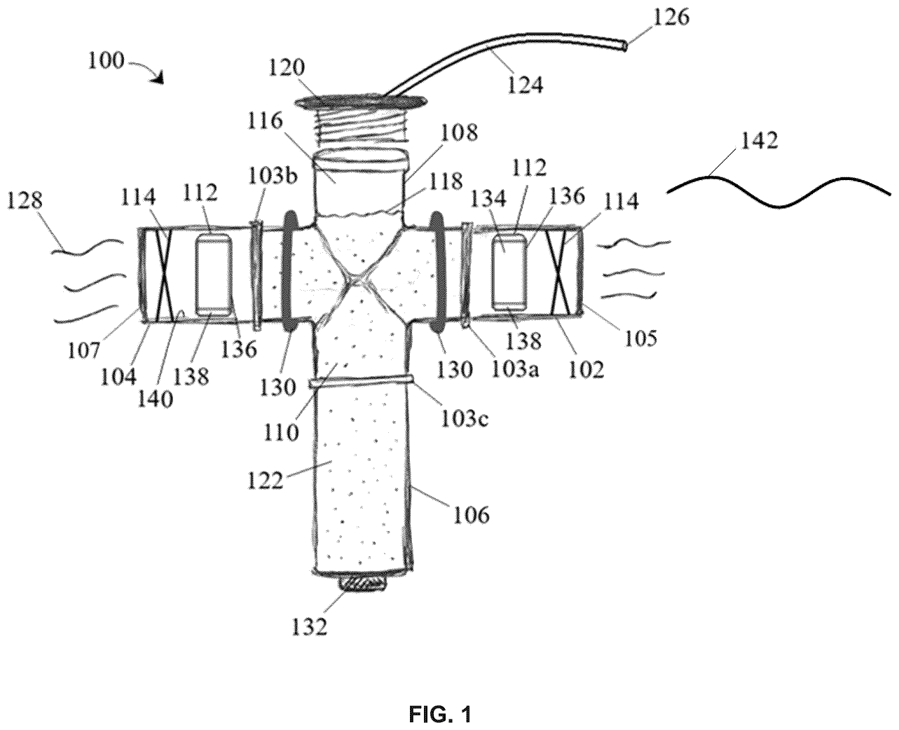

Referring now to FIG. 1, depicted is a non-limiting example buoy 100. The buoy 100 is a buoyant structure capable of floating in water at least when empty of payload. The buoy 100 includes a tubular structure composed of tubular members which may include a first arm 102, a second arm 104, a third arm 106, and a fourth arm 108 all connected by a central member 110. However, it is understood that the buoy 100 need not be tubular; rather, any water-tight enclosure can be used. Non-tubular shapes may also be utilized, including spherical, ellipsoidal, conical, or jar/tank-like shapes.

Referring still to FIG. 1, the first arm 102, the second arm 104, the third arm 106, the fourth arm 108, and the central member 110 are composed of a rigid material capable of being immersed in water. In some examples, the first arm 102, the second arm 104, the third arm 106, the fourth arm 108, and the central member 110 are constructed from PVC, such as foamed (or expanded) PVC. Advantageously, foamed PVC provides for buoyancy to help the buoy 100 float. Like PVC, foamed PVC is also resistant to moisture and does not absorb water, making it capable of being immersed in water. However, other materials are possible and encompassed within the scope of the present disclosure. For example, the buoy 100 may alternatively be constructed out of LDPE, HDPE, polypropylene, polystyrene, polypropylene copolymer, or combinations thereof. The various components may be connected with suitable fittings. In other words, the first arm 102 may be attached to the central member 110 with a fitting 103a, the second arm 104 may be attached to the central member 110 with a fitting 103b, and the third arm 106 may be attached to the central member 110 with a fitting 103c. In the example illustrated in FIG. 1, the fourth arm 108 is formed from an integral part of the central member 110 and therefore does not utilize a fitting to attach to the central member 110. However, this is not necessary. Furthermore, the various tubular or other enclosure components are attached in a leak-free or water-tight manner, and therefore may optionally include a suitable adhesive (such as, but not limited to, PVC cement) between adjacent components.

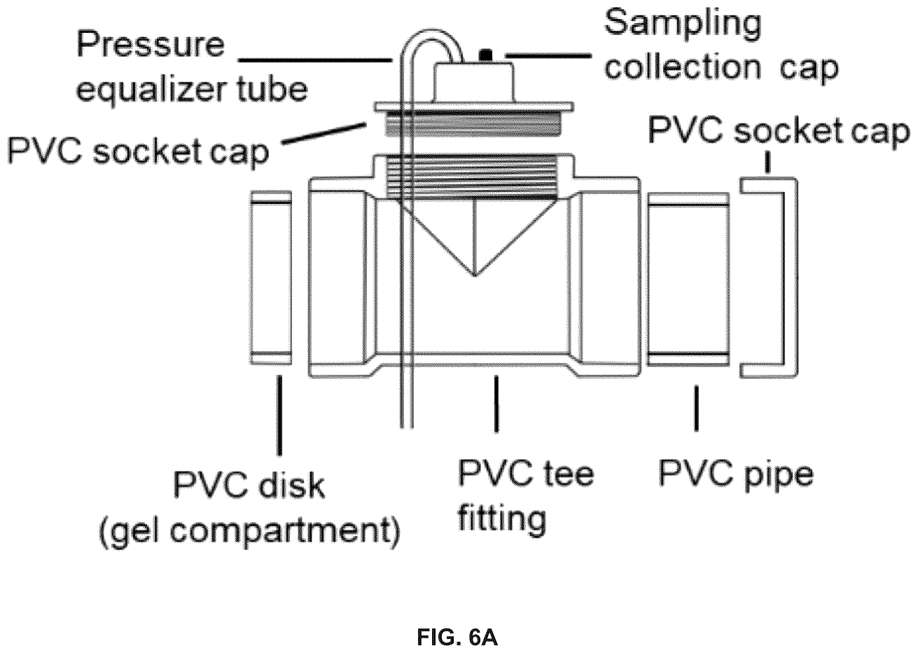

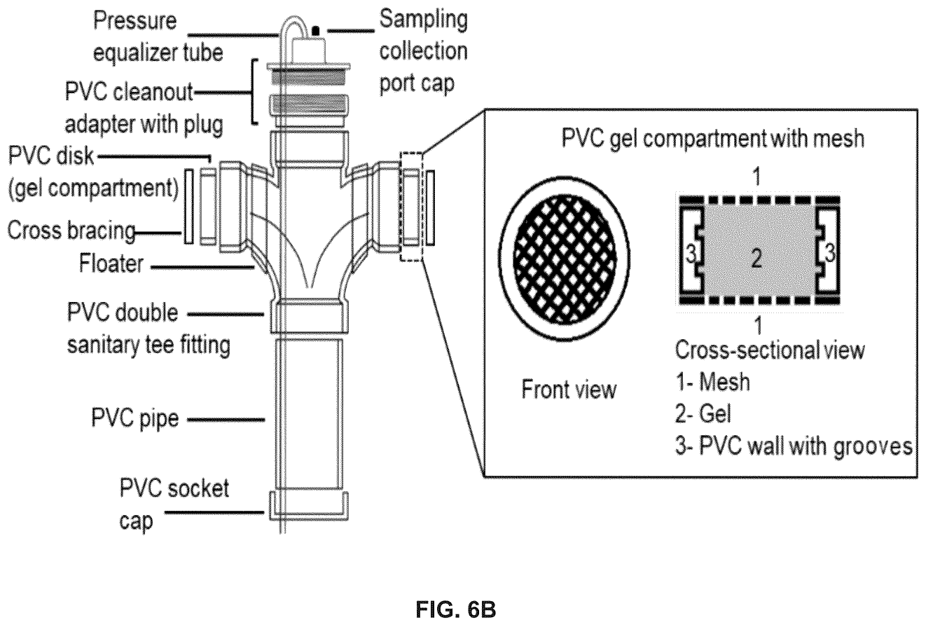

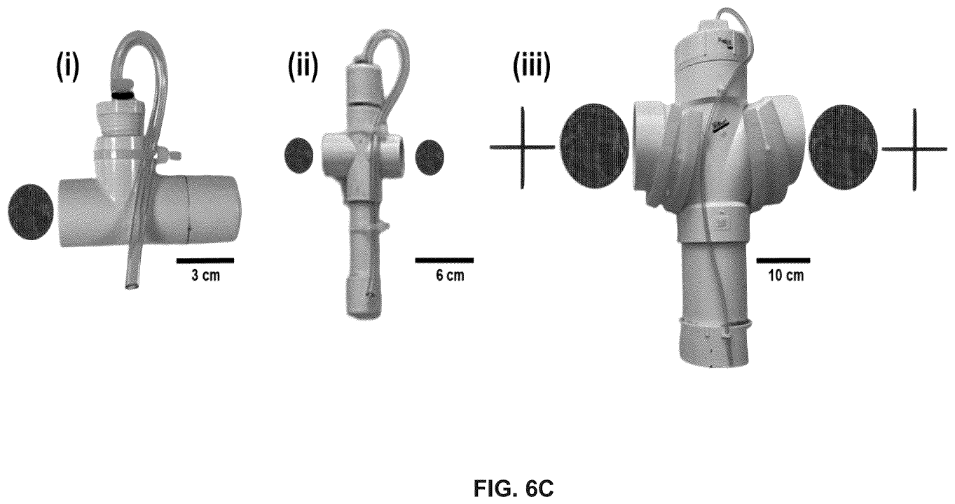

Referring still to FIG. 1, the first arm 102 and the second arm 104 may each house a gel disk assembly 112. The first arm 102 defines an opening 105, and the second arm 104 defines an opening 107. The openings 105, 107 each serve as an entrance for water into, and an exit for payload out of, the buoy 100. The gel disk assemblies 112 each include a hydrogel 134 and a mesh 136 configured to retain the hydrogel 134 in position in the gel disk assembly 112. The gel disk assemblies 112 may be formed from plastic rings 138 or other rigid housing components which include grooves on the inside to hold the hydrogel 134 in place within the ring 138, as depicted in FIG. 6B. Although a gel disk assembly is referenced herein, it is understood that any suitable structural arrangement—referred to generally as a gel assembly—may be employed to house hydrogels that are not of circular cross-section. The gel assembly may include rigid housing components of non-circular geometry, such as square, rectangular, octagonal, or other polygonal or irregular shapes, so long as they are configured to retain the hydrogel in a desired position. Such configurations would be readily recognized by a person having ordinary skill in the art as suitable for housing hydrogels of various shapes and sizes, depending on the specific application requirements. Although grooves in the housing components of the gel disk can enhance adhesion between the gel and the housing surface, their inclusion is not strictly required. Similar functionality may be achieved through alternative forms of surface texturing, such as non-groove-shaped depressions, open networks of coarse pores, arrays of indentations, or any other surface feature that a person having ordinary skill in the art would recognize as capable of providing comparable gel retention. The plastic rings 138 may fit snuggly within each of the first arm 102 and the second arm 104 such that water or other fluids cannot pass through a space between the gel disk assembly 112 and an inner wall 140 of the first arm 102 or the second arm 104. Optionally, a suitable sealant material may be used to ensure a water-tight fit of the plastic ring 138 within the first arm 102 or the second arm 104. However, although the gel disk assemblies 112 are described as including rings 138, it is understood that the gel disk assemblies 112 need not have a circular cross section and can, in fact, be any shape. The plastic material of the rings 138 may be any rigid plastic such as, but not limited to, PVC. The mesh 136 may be adhered to the outside of the plastic ring 138 so as to contain the hydrogel 134 within the gel disk assembly 112. In some embodiments, the mesh 136 may be replaced with a perforated or porous sheet or film. The purpose of the mesh 126 or sheet or film is to keep the hydrogel 134 in place while allowing the payload to pass through holes in the mesh 136, sheet, or film. The gel disk assemblies 112 may also optionally include grippers for gripping the inner walls 140 of the respective arm 102, 104 to keep the gel disk assembly 112 in position within the respective arm 102, 104. The grippers may help ensure that water or other fluids cannot pass through a space between the gel disk assembly 112 and an inner wall 140 of the first arm 102 or the second arm 104.

Referring still to FIG. 1, for a fluid to pass from one side of the gel disk assembly 112 to the other, the fluid must diffuse through the hydrogel 134. This means that payload housed within the buoy 100 must diffuse through the hydrogel 134 in order to exit the buoy 100 as released payload 128 through either the opening 105 of the first arm 102 or the opening 107 of the second arm 104. In alternative embodiments, however, a portion of a payload could pass through a portion of the buoy (e.g., opening in an arm) that is distinct from the hydrogel in order to exit the buoy. The first arm 102 and the second arm 104 may each also house a bracing structure 114. The bracing structure 114 acts as a barrier from physical objects which may float into or otherwise enter the first arm 102 or the second arm 104. The bracing structure 114 protects the gel disk assemblies 112 by preventing forceful contact with such physical objects. Furthermore, the bracing structure 114 helps to keep the gel disk assemblies 112 in place when the gel disk assemblies 112 are subjected to hydrostatic or osmotic stress.

The hydrogel 134 in the disk assemblies 112 can be any hydrogel capable of maintaining its integrity in water. Ideally, the hydrogel 134 should be stiff and resilient, and should exhibit minimal swelling. Any hydrogel 134 with minimal swelling (or deswelling/contraction) and that is mechanically robust will work. The lack of deswelling and contraction is important because if the hydrogel 134 contracts in response to changes in conditions during use of the buoy 100, such contraction could cause the buoy 100 to leak. The hydrogel 134 may be, for example, a covalently crosslinked PAA The hydrogel 134 may also be a dual-crosslinked PAA. The hydrogel 134 may be formed, for example, from a free-radical polymerization of an aqueous solution containing acrylic acid (AA), MBA, AlCl₃, and APS. In one non-limiting example, the hydrogel 134 is formed from a free-radical polymerization of an aqueous solution containing about 1 M AA, about 4 wt % MBA, about 1 wt % AlCl₃, and about 0.4 wt % APS. However, other hydrogels 134 are possible and encompassed within the scope of the present disclosure.

Referring still to FIG. 1, the third arm 106 includes a reservoir or chamber 122 configured to hold a payload. When empty, the reservoir 122 provides buoyancy. The reservoir 122 may extend into the central member 110 as well as some of each of the first arm 102 and the second arm 104 depending on the volume of payload the user desires to fill the buoy 100 with. The volume of the reservoir 122 may be tailored for the desired application. In some cases, the reservoir 122 may have a volume ranging from about 1 mL to about 4,500 mL. However, other sizes are possible and encompassed within the scope of the present disclosure. The payload can be, for example, a liquid or solid granules. The payload can be an algaecide, a pesticide, a disinfectant, a dye, combinations of materials described herein, or any other composition intended to be delivered into an aqueous environment. Non-limiting example payloads include copper-based algaecides such as copper sulfate and copper chelates; quarternary ammonium compounds such as polyquaterniums and alkyl dimethyl benzyl ammonium chlorides (ADBACs); polymeric algaecides such as poly [oxyethylene(dimethyliminio)ethylene(dimethyliminio)ethylene dichloride]; peroxygen compounds such as sodium carbonate peroxyhydrate; copper-free algaecides such as sodium bromide and potassium monopersulfate; ethylene diamine tetraacetic acid (EDTA), optionally in combination with copper; simazine; Oxymycin™ P5, which is a combination of peracetic acid, hydrogen peroxide, and acetic acid; sodium hypochlorite (liquid chlorine); calcium hypochlorite (Cal-Hypo); trichloroisocyanuric acid (Trichlor); sodium dichloroisocyanurate (Dichlor); bromine; biguanides, such as polyhexamethylene biguanide; potassium monopersulfate; sodium carbonate; and sodium bisulfate.

The fourth arm 108 includes an air gap 116 above a fill level 118 of the payload. The air gap 116 can help improve the buoyancy of the buoy 100. The buoy 100 includes a cap 120 configured to securely close the fourth arm 108. The cap 120 is removable so as to provide access to the reservoir 122 to fill or reload the buoy 100 with payload. The cap 120 may have external threads configured to mate with internal threads on the fourth arm 108. However, other methods and structures for removably attaching the cap 120 to the fourth arm 108 are possible and encompassed within the scope of the present disclosure. Referring still to FIG. 1, the cap 120 includes a pressure equalizer tube 124 configured to vent air from within the central member 110 to an outside environment. Although the inclusion of the pressure equalizer tube 124 is advantageous when used with payloads that generate gases it is not strictly necessary, and moreover, can cause problems when the payload consists of large molecules (those that are much larger and slower-diffusing than water) at high concentrations. The pressure equalizer tube 124 allows for the release of pressure which may build up inside the buoy 100 due to gas generation within the reservoir 122 or the loading of the payload into the buoys. However, when the payload consists of large molecules and the diffusion of these larger molecules out of the buoy is significantly slower than the diffusion of water into it, the resulting high osmotic pressure can draw water into the buoy through the gel. If the buoy is exposed to ambient pressure via the tube (rather than being sealed), this influx can dilute/increase the volume of the payload solution, causing it to be ejected through the top of the buoy or the pressure equalizer tube. Conversely, when the buoy is sealed off from ambient pressure, the osmotic pressure is counterbalanced by the compressed air present in the buoy's headspace, which minimizes the osmotic pressure-driven water influx. Thereby, inclusion of the pressure equalizer tube is advantageous in scenarios where the payload is expected to generate gas during deployment (i.e., where H₂O₂ slowly decomposes into O₂ and H₂O) and where osmotic pressure-driven water influx effects are expected to be small. In use, the pressure equalizer tube 124 may be secured to the outside of the buoy 100 with a clip or other fastener such that the outlet 126 of the pressure equalizer tube 124 is disposed below the water level 142 in the aqueous environment in which the buoy 100 is deployed. While it is not strictly necessary for the pressure equalizer tube 124 to be below the water level 142, with its opening pointing downward, in scenarios where the payload is expected to generate gas during deployment and where osmotic pressure-driven water influx are expected to be small, this arrangement prevents debris from the atmosphere from entering the buoy 100. The cap 120 may further include a sampling collection port. However, this is not strictly necessary.

The central member 110, the first arm 102, and/or the second arm 104 may optionally include a floatation aid 130, such as a ring, or partial ring, surrounding the respective component 110, 102, 104, to aid the floatation of the buoy 100. While a ring, or partial ring, have been described as a floatation aid, any suitable buoyant material having any suitable structure attached to a buoy can be utilized. Though FIG. 1 depicts the floatation aids 130 as rings, the floatation aids 130 need not be ringlike or circular in shape, and need not completely encircle any of the central member 110, the first arm 102, or the second arm 104. Furthermore, the third arm 106 may include an additional, optional buoyant member 132 attached thereto. However, these additional components for added buoyancy are not strictly necessary, and embodiments without these optional structures are encompassed within the scope of the present disclosure. The desired buoyancy can be achieved based on the selection of materials for constructing the buoy 100, the volume of the reservoir, the volume of the air gap 108, and the number and size of the optional buoyant member 132 and floatation rings 130.

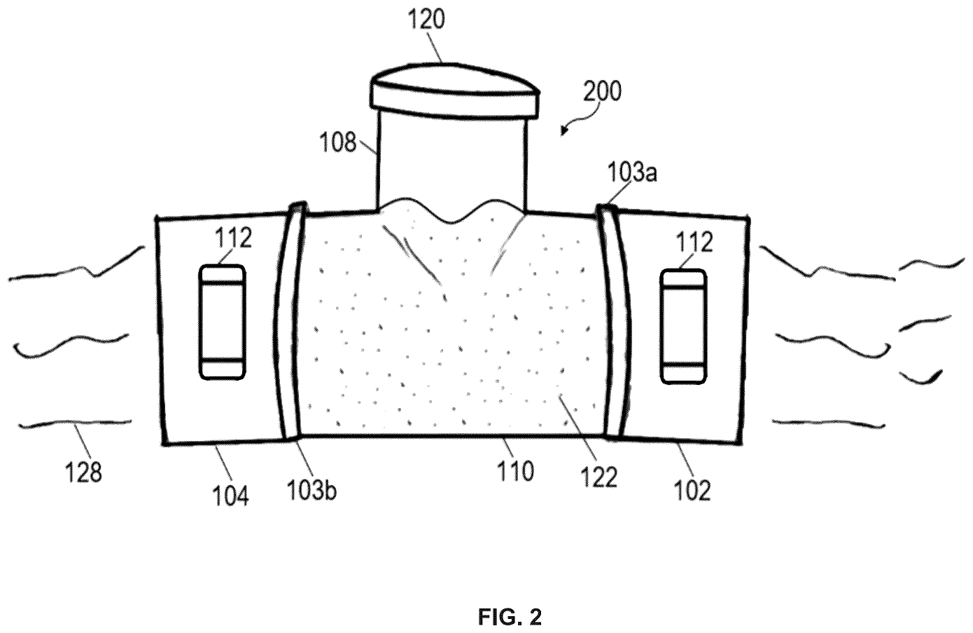

Referring now to FIG. 2, depicted is a buoy 200 having a smaller reservoir 122 than the buoy 100 depicted in FIG. 1. The buoy 200 includes a first arm 102 and a second arm 104, but does not include the third arm 106. Instead, the reservoir 122 is limited to being within the central member 110. The buoy 200 still includes a fourth arm 108 having a cap 120. When the buoy 200 is capped, the only way for a payload within the reservoir 122 to escape the buoy 100 is to diffuse through one of the gel disk assemblies 112 in the arms 102, 104.

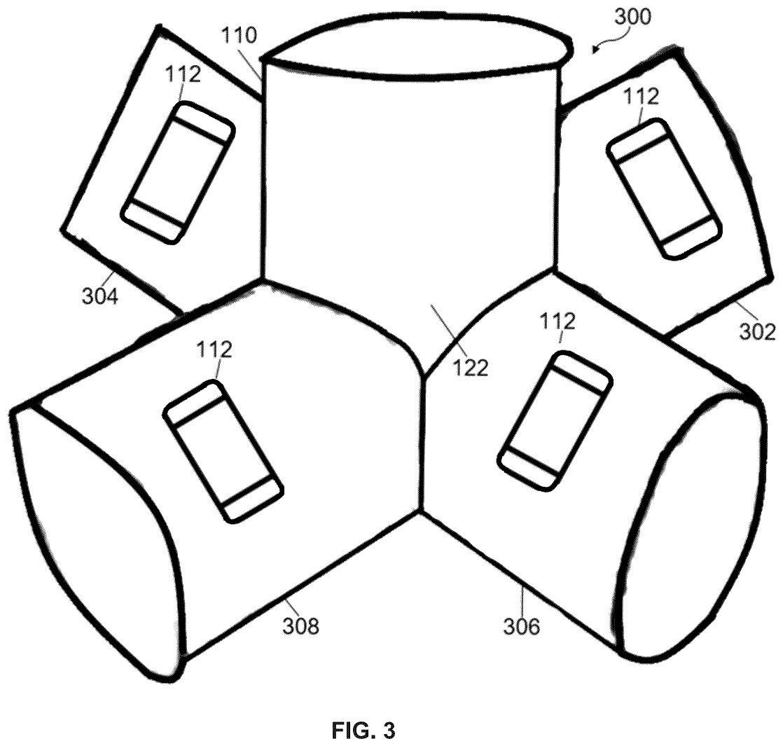

Referring now to FIG. 3, depicted is a buoy 300 formed from a five-way connector. The buoy 300 includes a central member 110 to which a cap 120 may be secured, and four arms 302, 304, 306, 308 each including a gel disk assembly 112. The reservoir 122 is contained within the central member 110, such that when the central member 110 is capped, a payload within the reservoir 122 can only escape the buoy 300 by diffusing through the gel disk assemblies 112 so as to exit through one of the arms 302, 304, 306, 308.

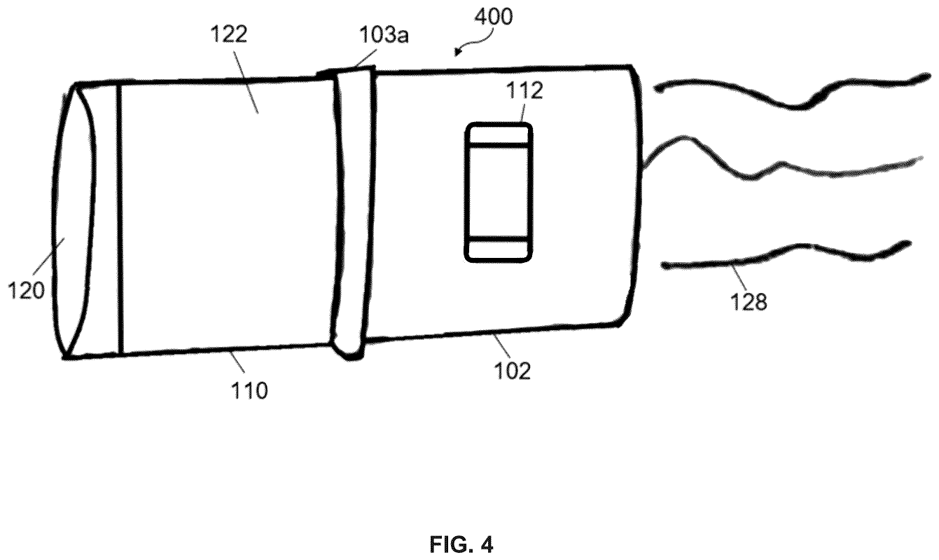

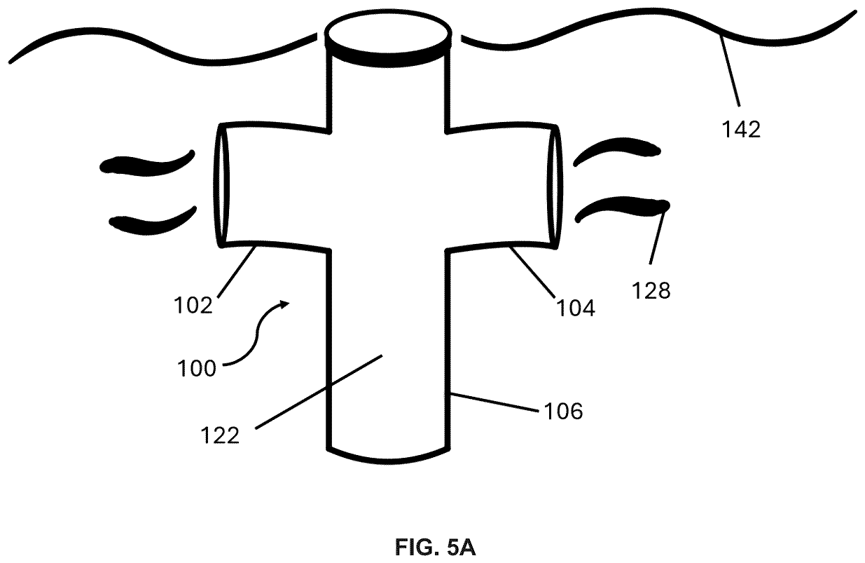

Referring now to FIG. 4, depicted is a buoy 400 having only one arm 102 with a gel disk assembly 112. Specifically, the buoy depicted in FIG. 4 includes a first arm 102 with a gel disk assembly 112 disposed therein. The reservoir 122 is contained within the central member 110, which is a small tube having a cap 120 attachable thereto. When the buoy 400 is capped, the only way for a payload disposed within the reservoir 122 to escape the buoy 400 is to diffuse through the gel disk assembly 112 so as to exit through the first arm 102.

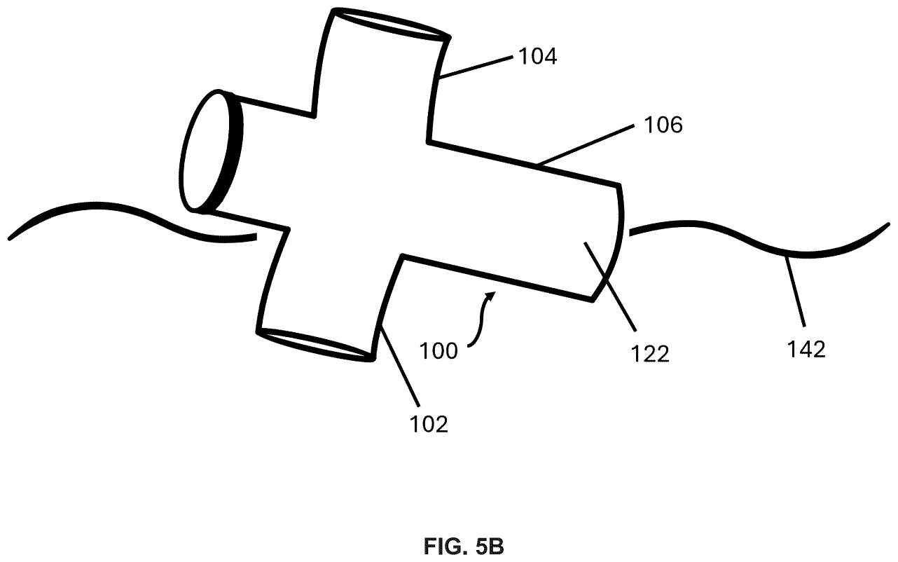

Referring now to FIGS. 5A-5B, a buoy 100 as described herein may be configured to float in a different orientation upon discharge of its payload so as to indicate its empty status, to alert users that it is time to refill the buoy 100. As seen in FIG. 5A, in a first state in which the buoy 100 is substantially filled with a payload, the buoy 100 floats at the water level 142 such that the third arm 106 is disposed deeper below the water level 142 than the first arm 102 and the second arm 104. As payload from within the reservoir 122 is released, the released payload 128 is below the water level 142. As seen in FIG. 5B, in a second state in which the buoy 100 is substantially free of payload (i.e., the reservoir 122 is substantially empty), the buoy 100 floats at the water level 142 such that the third arm 106 floats at substantially the same depth as the first arm 102 and the second arm 104. In other words, as the payload is released from the buoy, the third arm 106 becomes more buoyant and rises in the water column until the third arm 104 floats at the surface. This indicates to an operator that the buoy 100 is ready to be refilled with payload.

The buoys described herein can provide sustained release of active ingredients into water over timescales exceeding 1 month. The release profiles achieved from these devices are highly predictable and can be readily tailored. The buoys can improve the reliability of algacidal treatments of CHABs, and can be used in many other applications beyond controlling algal blooms. These include pest control in rice fields, sustained disinfection, and delivering pool chemicals. The buoys also have many advantages over conventional devices. Unlike the coated granulate- and gel bead-based sustained algaecide release technologies, which are single-use and can be displaced from their target application sites, regular commercial algaecide can be loaded into the buoys described herein, which (1) can be immobilized or anchored precisely where the algicidal effect is most needed, (2) can be refilled and reused once they release their payload, (3) are removable from the water after their use, which minimizes the amount of encapsulant material left in the water and after the algicidal treatment, and (4) can be imparted with a buoyancy-based mechanism for sensing when the buoys require refilling.

### EXAMPLES

In these examples, the hydrogels used to control the release from the buoys were characterized through gravimetric, mechanical, and spectroscopic analyses. Using a model peroxide-based algaecide, spectroscopic analyses were then employed to examine the factors controlling the sustained release rates from the algaecide-releasing buoys. Finally, to analyze their performance as tools for early-stage CHAB treatment, a microcosm experiment was conducted via fluorescence-based chlorophyll-a (Chl-a) quantification while simultaneously tracking the algaecide concentration evolution within the lake water. Taken together, these experiments shed light on the feasibility of constructing buoys for sustained algaecide release and provide early guidelines on their performance in the early treatment/mitigation of CHABs.

### Materials and Methods

Oximycin™ P5 was a kind gift from the SePRO Corporation (Carmel, INAA, APS, sodium chloride (NaCl), and MBA were purchased from Fisher Scientific (Ward Hill, MA). Aluminum chloride (AlCl₃) was obtained from TCI America (Montgomeryville, PA). The Plumber's Choice ½″×1080″ poly (tetrafluoroethylene) (PTFE) thread-seal tape (1210805), Everbilt ¼″-20×5/16″ nylon hex bolts (829318), Everbilt 20 orings (866410), Oatey® Regular PVC Cement (302483), and all PVC pipes and connections were purchased from Home Depot (Toledo, OH). The pipes and connections included: a 4″×10′ Sch. 40 PVC drain-waste-vent (DWV) pipe (04005.0600), ½″ Sch. 40 S×S×FPT PVC tees (024010610HD), ½″ Sch. 40 PVC socket caps (021160600HD), ½″ Sch. 40 PVC plugs (021130600HD), 4″ PVC DWV cap (021161200HD), 1″×10′ Sch. 40 PVC DWV pipe (040100600RS), 1″ Sch. 40 S×S×S×S PVC cross fittings (024100800HD), 4″ PVC DWV double sanitary tec fittings (001161200HD), 4″ PVC DWV double sanitary tec fittings (004281200HD), a 4″×10′ PVC Sch. 40 DWV pipe (074000600), and 4″ PVC DWV FTG cleanout adapters with plugs (00105.X1200HD) (all manufactured by the Charlotte Pipe and Foundry Co.), and an IPEX 4″×24″ Sch. 40 Rigid PVC foam-core pipe (2204). A vinyl mesh (17718701) was supplied by JOANN Fabrics and Crafts (Toledo, OH). An acrylonitrile styrene acrylate (ASA) 3D printing filament was bought from Polymaker LLC (Missouri City, TX). Polyethylene foam pool noodles (OD-3845-NOODLE) were purchased from FixFind (Chanhassen, MN). Unless otherwise stated, all experiments were performed using deionized water with a resistivity of 18.2 MΩ-cm from a Millipore Direct-Q 3 water purification system, and all materials were used as received.

### Algaecide-Releasing Gel Synthesis

The hydrogels were prepared by free-radical polymerization within cylindrical PVC molds, which also served as protective housings for the gels during their use. The PVC molds were prepared by cutting PVC pipes with internal diameters of ½″, 1″, and 4″ into 0.5-2.0-cm-thick slices and covering both their ends with vinyl mesh screens. The resulting gel molds were then placed into 40 or 100 mL screw-cap. cylindrical glass tubes in stacks of four with internal diameters of 2.5 cm and 3.6 cm, respectively, to form gels with ½ and 1″ diameters, or into 500 mL aluminum pans (equipped with lids) with an internal diameter of 12.7 cm to form 4″ diameter gels. The monomer/crosslinker/initiator mixtures containing 7.2 wt % (1 M) AA, 4-9 wt % (0.26-0.58 M) MBA, 1 wt % (70 mM) AlCl₃, and 0.4 wt % (17 mM) APS were then poured inside. The solutions were deaerated by purging with nitrogen for 2 h, followed by vacuum degassing under agitation for 15 min using a Gast (Benton Harbor, MI) compressor/vacuum pump. After deaeration and degassing, the glass tube and aluminum pan reaction chambers were sealed (by closing and wrapping with Parafilm®) and placed in a water bath, whereupon the temperature was gradually raised to 60° C. to initiate the polymerization and maintained for 12 h. The reaction chambers were then removed from the water bath and cooled on the benchtop for 1 h before opening. The resulting gel disk assemblies were then separated by hand and transferred to a 1 L beaker containing deionized water to wash away any low-molecular-weight unreacted reagents or byproducts and left to equilibrate for 3 days without agitation before use.

### Gel Characterization

The gels were synthesized as described above but not in 15 mL Falcon™ tubes. After the reaction was completed, the cylindrical gel monoliths (Ø=13 mm) were cut into 10-mm-thick discs and immersed in 1 L of deionized room-temperature water. The swollen gels were then periodically weighed, with excess surface solution removed using a Kimwipe™. These measurements continued for 1 month. The swelling ratio was calculated as:

$$Normalized Weight = \frac{W ( t )}{{W}_{0}} \qquad ( 1 )$$

where W(t) is gel weight at time t and W₀ is the initial gel weight. Each gel composition was analyzed in triplicate.

To also characterize compositional effects on the mechanical properties, compression testing was performed, where the Young's modulus was estimated from the initial slope (up to 6% strain) of the stress-strain curve. The gels for these measurements were prepared similarly to those used for the swelling analysis, whereupon they were washed and equilibrated in 1 L of deionized water for 14 days. They were then sliced into 1-cm-long segments, loaded onto an Instron 5566 Universal Testing Machine (UTM; Norwood, MA) equipped with a 10 kN load cell, and compressed (while measuring both the crosshead displacement and the applied force) at a crosshead speed of 2 mm/s. Six replicate samples were tested at each gel composition.

Since the transport of the H₂O₂ algaecide should depend on its partitioning into the gel barriers, the H₂O₂ partition coefficient between the gels and surrounding water was also determined. Here, gels prepared in 15 mL Falcon tubes, cut into 1-cm-thick discs were again used. Each gel disc was then placed in a test tube with an equal volume of 0, 1, 2, 3, and 4 mg/L or commercial-strength Oximycin™ P5 (27.5 wt % H₂O₂) solution, and each test tube was sealed with a septum and equilibrated for 24 h while agitating at room temperature and 200 rpm using a Benchmark Scientific Multi-Therm shaker (South Plainfield, NJ, USA). The final solution-phase H₂O₂ concentrations (once the H₂O₂ partitioned into the gels) were measured by UV spectroscopy (2=351 nm: using the same Varian Cary 50 spectrophotometer), and the gel-phase H₂O₂ concentrations were then calculated (from the overall H₂O₂ content and that remaining in solution) using a species mass balance. The equilibrium gel- and solution-phase H₂O₂ concentrations were then used to determine the H₂O₂ partition coefficient through a linear regression of the gel-phase versus the solution-phase equilibrium H₂O₂ concentration data. Each measurement in this experiment was performed in triplicate.

### Buoy Construction

Refillable/reusable algaecide-releasing buoys were constructed from commercial PVC tubes in three sizes: small, medium, and large, with algaecide solution capacities of 20, 145, and 4500 mL, respectively (FIGS. 6A-6C). All three models controlled the algaecide release by allowing it to diffuse across gel disks, which measured either 0.5, 1.0, or 2.0 cm in thickness. The small buoy contained only one algaecide-releasing disk (FIGS. 6A, 6C (i)), while the medium and large ones contained two gel disks and released the algaecide from two diametrically opposed locations (FIGS. 6B, 6C (ii)-(iii)). The small and medium buoys were constructed from solid PVC pipes. In the large buoy, however, the lower section was composed of a PVC pipe with a foam core (FIG. 6B). This feature both improved buoyancy and, more importantly, allowed the buoy to transition from a vertical to a horizontal position when the algaecide is released (and the density of the internal solution drops from the 1.12 g/mL density of Oximycin™ P5). This transition could serve as an indicator of when to refill the buoy (vide infra). Styrofoam floats (prepared from 33-cm-long swimming pool noodle segments cut in half longitudinally) were also added to the buoys to ensure buoyancy (though this foam attachment step was skipped during experiments on the small and medium buoys where, as will be described later, buoy floatation was achieved by attaching them to the tops of beakers and buckets).

The algaecide release-rate-controlling gel disks were housed inside of PVC pipe slices, with matching 0.5-2.0 cm thicknesses and internal diameters of either ½, 1, or 4″. The gel synthesis was performed in situ, as described above, and to ensure that the PVC frames grip the gels (whose diameters also matched those of their frames) firmly, two 1-mm-deep grooves were made on the internal surface of the PVC slices (see FIG. 6B; except for the 0.5-cm-thick slice, which contained only one groove). These grooves both enabled mechanical interlocking and increased the contact area between the gels and their frames, which helped to prevent leakage at the gel disk/PVC frame interfaces. To further stabilize the gels within their frames, vinyl meshes (65% PVC and 35% polyester) were affixed to both exposed gel surfaces by gluing the meshes to the PVC frames with PVC cement (FIGS. 6B, 6C). The disks were then firmly inserted into the buoy openings (as shown in FIGS. 6A-6C). In the case of the large buoys, where the 4″ gel disks were subjected to a significantly higher hydrostatic force than their smaller counterparts, a 3D-printed ASA cross-bracing—produced using a LulzBolt TAZ 6 (Fargo, ND) filament-fed 3D printer—was also attached to the outer wall of each gel disk to prevent gel deformation during the filling of the buoys (see FIG. 6C (iii)).

Additionally, all buoys were equipped with simple pressure relief valves. Although the peroxide algaecide used in this study was stable, a small fraction of it does degrade, producing O₂ inside the buoys. This gas generation elevates the internal pressure and can cause leaks around the edges of the gels. To prevent this, a tube-based direction control valve was installed at the top of the device to relieve pressure and balance the internal and external pressures (FIGS. 6A-6C). This tube allows the generated O₂ to be released without allowing water or dust to enter the buoy. A second nylon bolt-sealed opening was also added to the tops of the buoys for sampling the internal algaecide concentration during the experiments.

### Sustained Release Experiments

To characterize the sustained release rates afforded by these buoys, a parametric study of factors controlling the algaecide release kinetics was performed. The first experiment examined the effect of the gel disk thickness on the peroxide release, using the small buoy (with an internal volume of 20 mL) with a fixed, commercial-strength (27.5% H₂O₂) Oximycin™ P5 concentration, where the thickness of the gel disks was varied between 0.5 cm, 1 cm, and 2 cm. Next, the impact of the initial algaecide concentration within buoys was explored. Here, gel disks of 1 cm thickness were used with the same buoys, while varying the Oximycin™ P5 concentrations (through dilution in deionized water) between 1%, 5%, and 27.5% H₂O₂. Lastly, the effect of the buoy size on the release achieved was investigated using all three devices depicted in FIG. 6C. While the small and medium devices were filled with commercial-strength (27.5% H₂O₂) Oximycin™ P5, the large devices were, to preserve supplies, loaded with diluted (5% H₂O₂) Oximycin™ P5. In each experiment, the peroxide concentrations in the release media were determined by the Is method, adapted to a Cary 50 UV-vis spectrometer (Sparta, NJ).

After loading the buoys with the peroxide solution, they were submerged in water. Small buoys were affixed in 1-L deionized water-filled beakers using paperclips and zip ties, whereupon the aqueous release medium was stirred at 100 rpm with 50 mm×8 mm cylindrical magnetic stir bars. Medium-sized buoys were placed in 25-L deionized water-filled buckets, secured similarly to the small buoys, after which the 25 L of the release medium was stirred at 1800 rpm using CNCEST (Kowloon, Hong Kong) overhead stirrers equipped with 30-mm, 3-pitched blade impellers. Large buoys were placed in 47-gal drums filled with 170 L of tap water, secured with polyester cords, and then allowed to release their contents into the tap water, which was stirred at 1800 rpm using 50-mm half-moon impellers fitted to the same overhead stirrers. Water samples from the release media were then collected at predetermined time intervals and analyzed to determine the H₂O₂ concentration (based on absorption at λ=351 nm). Additionally, internal H₂O₂ concentrations within the buoys were tested every 7 days by collecting samples through the sampling collection port (accessible through the temporary removal of the sampling collection port cap in FIG. 6B). Using a syringe with a stainless-steel needle, approximately either 0.2 mL (from the small and medium buoys) or ˜1.1 mL (from the large buoys) of the internal algaecide solution was collected. These samples were diluted in deionized water up to 25,000× and analyzed using UV-vis spectroscopy as described above. Each experimental condition was analyzed in triplicate.

### Algacidal Activity Analyses

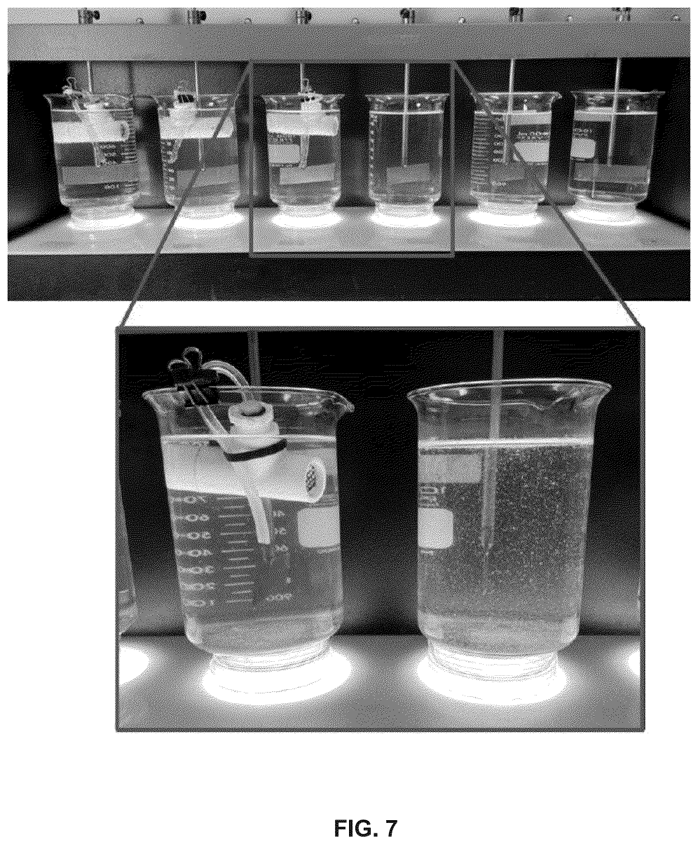

To begin assessing the impact of our peroxide release device on algae concentrations, an experiment was conducted using Lake Erie water, collected on Sep. 21, 2023 at the University of Toledo's Lake Erie Center (near Oregon, OH, at coordinates 41° 41′ 27.4″ N, 83° 23′ 52.8″ W). Six 1-L beakers were filled with water from Lake Erie, with the algae concentration adjusted to approximately 2000 cell/ml by dilution using filtered lake water. A small buoy (internal volume: 20 mL; see FIG. 6A and FIG. 6C (i)) loaded with diluted Oxymycin™ P5 (containing 6 g/L H₂O₂) was added to three of the beakers, while the remaining (untreated beakers) served as the negative control. The buoys were then secured at the top of the water column with nylon zip ties and paper clips (see FIG. 7), whereupon the beakers were placed into a jar tester (Model PB-700, Phipps & Bird, USA) and subjected to constant 6-rpm agitation and controlled 12-h light cycles over 14 days. To mimic water addition/withdrawal in small DWTP reservoirs, 10% of the water from each beaker was replaced every 24 h with fresh lake water (taken from the same batch as that used initially, which was stored at 4° C. before use). The withdrawn water was then used to quantify the Chl-a concentration to assess changes in the cyanobacterial concentration.

The Chl-a was determined through extraction followed by fluorometric measurements, in accordance with a standard laboratory methodology. Twenty mL of water were filtered using 0.7-μm Whatman GF/F microfiber filters, and the filters were then stored at −80° C. After collecting all samples, each filter was immersed in 10 mL of dimethyl sulfoxide (DMSO), sonicated for 45 s, followed by a 45-s immersion in an ice bath, repeated for three cycles, and subsequently left in the dark at room temperature for 22-24 h. Following this incubation, the samples were centrifuged using an Eppendorf 5804R centrifuge (Germany) at 5000 rpm (2100 g) for 15 min. The fluorescence of the supernatant was measured using a Shimadzu RF-6000 spectrofluorometer (Japan). Statistical differences between the control and treatment groups (p<0.05) were determined via the Student's two-tailed t-test for independent samples with unequal variance.

### Results and Discussion

### Gel Formation and Characterization

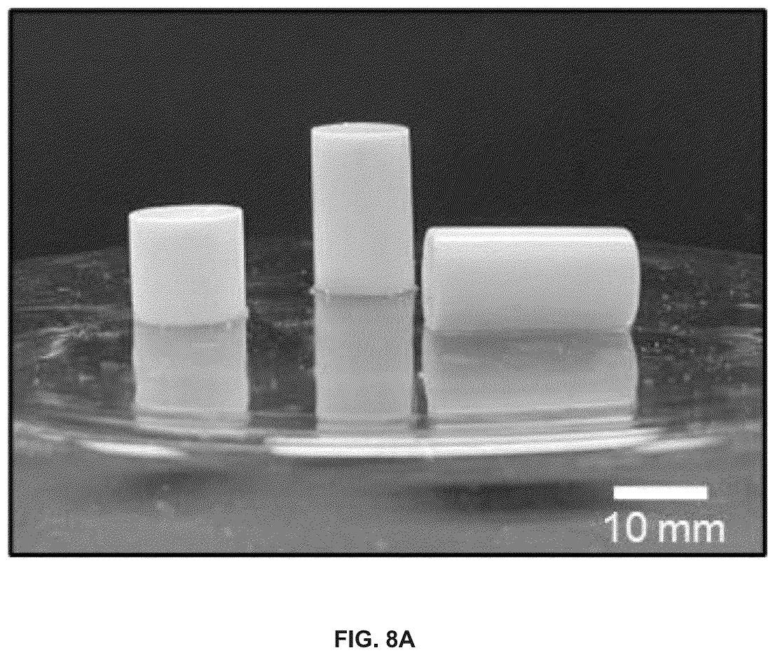

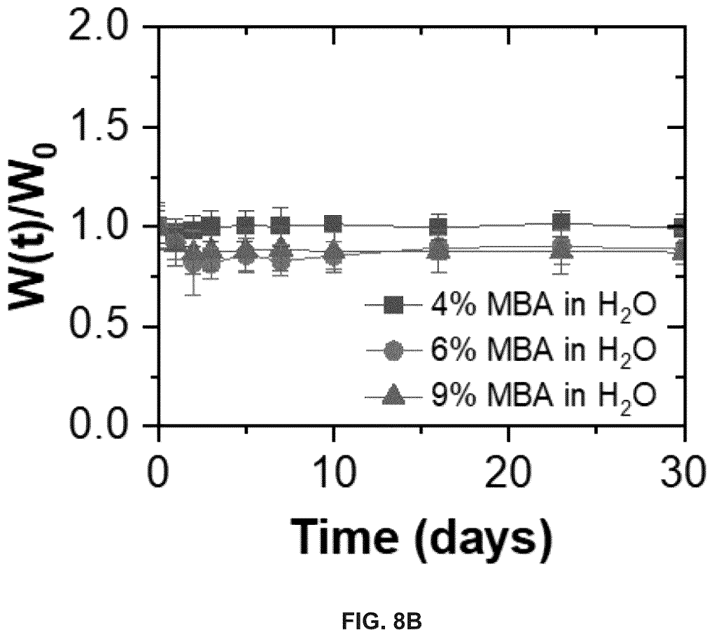

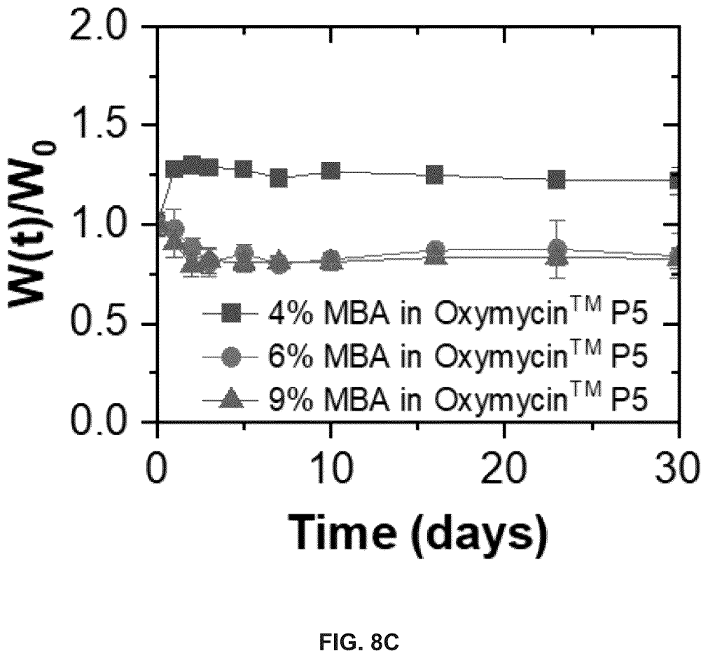

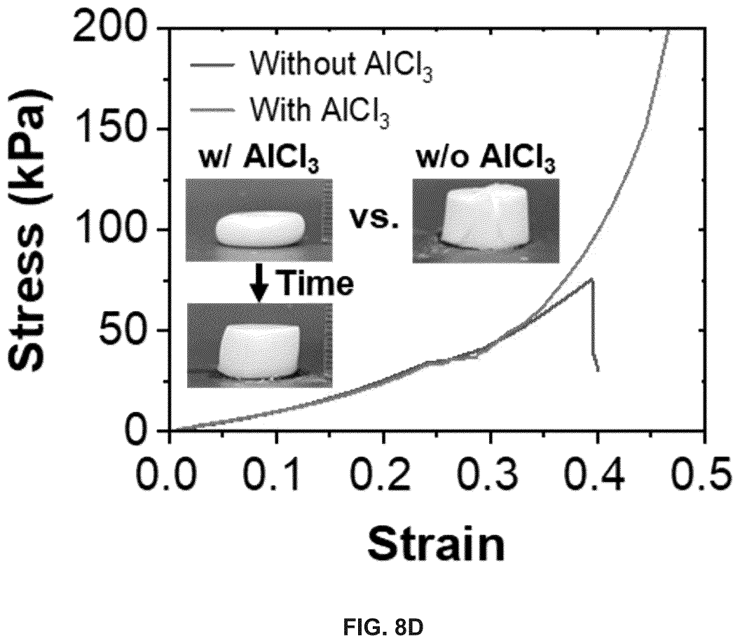

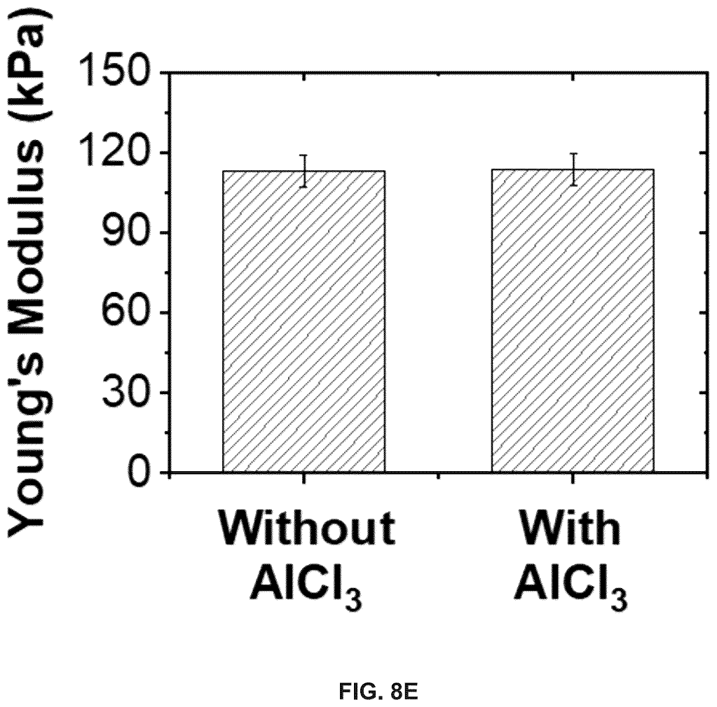

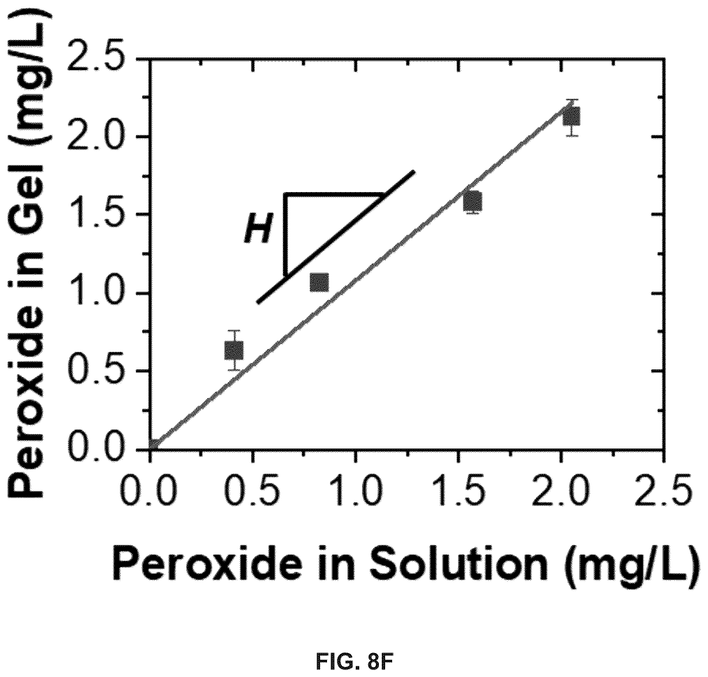

Upon polymerizing, the clear solution transformed into an opaque gel, where the opacity indicated significant heterogeneity in the gel structure and was characteristic of highly crosslinked chemical gels (FIG. 8A). On being removed from the reactors, gels formed at lower MBA concentrations were (based on qualitative observations on manual handling) were softer and more elastic, while gels formed at higher MBA concentrations were stiffer and more brittle. These observations were consistent with established polymeric gel behavior, where crosslink density is a key determinant of mechanical characteristics.

Besides the importance of the gel mechanical properties, it is important that the gels maintain their dimensions (i.e., do not excessively swell or shrink when inserted into the buoys). If they swell too much, they may damage (or be damaged by) the meshes keeping them in place or, by slowly increasing the thickness of the algaecide diffusion barrier, undermine the uniformity of the algaecide release profile. Conversely, if the gels deswell/contract, they can create gaps between their edges and their PVC housing, thus undermining the controlled release via the convective leakage through these gel disk/PVC frame gaps. To this end, long-term swelling behavior of gels synthesized at variable 4-9 wt % MBA concentrations was characterized (in terms of their normalized weight, W (t)/Wo) over 1 month. Gels prepared at the lower, 4 wt % MBA concentration maintained a roughly constant weight (within ˜100% of its initial value) when immersed for 1 month in deionized water and modestly swelled (by ≤30%) when immersed in commercial-strength algaecide Oxymycin™ P5 (squares in FIGS. 8B-8C). Gels prepared at higher, 6-9 wt % MBA concentrations, however, underwent syneresis (losing ˜13-20% of their weight through the expulsion of water) over the first 2-3 days in both deionized water and commercial-strength algaecide Oxymycin™ P5, after which the gel weights remained stable (circles and triangles in FIGS. 8B-8C). Because the lowest MBA concentration avoided the leak-causing gel shrinkage with only modest swelling, it was chosen as the gel composition for the buoy design in an embodiment.

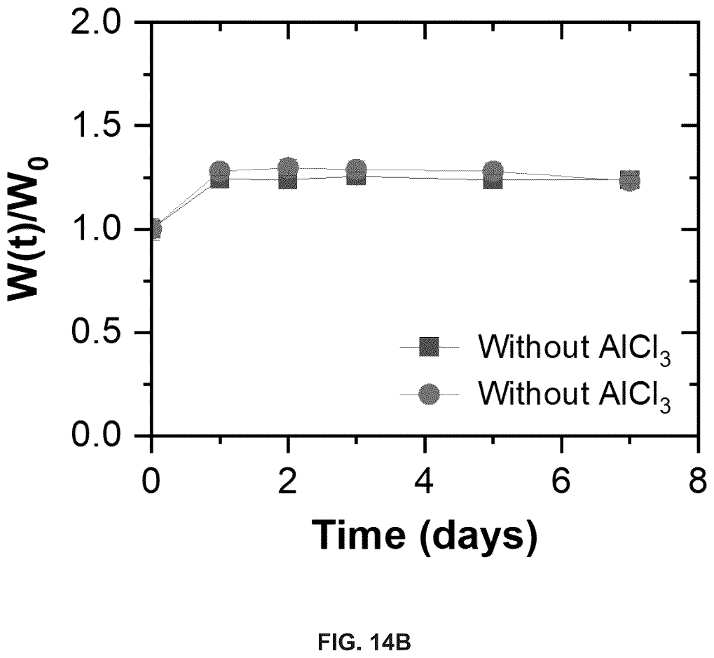

Also notable was the effect of AlCl on the gel properties. The presence of 1 wt % AlCl₃ prevented the swelling of the 4 wt % MBA gels in deionized water (though it interestingly had no impact on their modest swelling in Oxymycin™ P5; FIGS. 14A-14B). More importantly, AlCl₃ addition enhanced the hydrogel mechanical properties. The initial slopes in the stress-strain curves and corresponding Young's moduli (˜110 kPa) were similar, regardless of whether 1 wt % AlCl was used in the gel synthesis (FIGS. 8D. 8E). Despite this lack of effect on the stiffness of these highly crosslinked gels, however, AlCl₃ inclusion had a pronounced effect on the gel toughness. While the AlCl₃-free gels fractured on compression to a ˜70-90 kPa engineering stress, this fracturing was considerably suppressed when AlCl was used, with visible gel cracking only being limited to the gels' edge as the gels were compressed into pancake-shaped disks (inset in FIG. 8D). Notably, this enhanced stability to compression (i.e., lack of complete gel failure) persisted even when the compression stress reached ≥ 10 times that needed to fracture the AlCl₃-free gels. This behavior was attributed to the additional, ionic/coordination bond crosslinking mediated by the Al³⁺ ions and was qualitatively consistent with the high toughness and recovery/shape memory properties reported previously for dual (covalently and ionically) crosslinked gels. The insensitivity of the Young's modulus to the Al³⁺ addition, however, differed from the trends observed in other studies, where the addition of supramolecular crosslinks to the covalent ones also produced an increase in the gel stiffness. While origins for this difference remain to be explored, it is believed that this insensitivity of the gel modulus to further crosslinker addition may stem from the extremely high covalent crosslink density used in the gel synthesis, which gave rise to inhomogeneous gels (as evidenced by their high opacity). Since gel inhomogeneity can reduce the number of elastically effective crosslinks, it is possible that further crosslinker addition did not significantly increase the stiffness of the highly crosslinked gels due to their inhomogeneity.

Additionally, to characterize the partitioning of the H₂O₂ algaecide into the gel (which, as will be discussed later, affects its release rate), H₂O₂ partitioning between the gels and the surrounding solution was characterized using the preferred, 4 wt % MBA gel formulation, by determining the equilibrium gel-phase H₂O₂ concentration, CAG, as a function of the equilibrium solution-phase H₂O₂ concentration, CAS (FIG. 8F). A linear regression of this data (solid line in FIG. 8F) revealed an H₂O₂ distribution coefficient (H, defined as the ratio between the gel- and solution-phase H₂O₂ concentrations at equilibrium, H≡C_{A}^{C}/C_{A}^{S}) of 1.08±0.06. The near-uniform H₂O₂ partitioning between the gel and surrounding water likely reflected the water-rich, aqueous environment within the hydrogel, while the subtle increase in the gel H₂O₂ concentration relative to that in the surrounding water (indicated by H being slightly higher than 1.00) pointed to H₂O₂ affinity exhibiting some (albeit weak) affinity for the gel. Although weak, this preferential H₂O₂ partitioning into the gel was also consistent with the increased swelling of these 4 wt % MBA gels when immersed in Oxymycin™ P5 relative to that in deionized water (cf. FIGS. 8B, 8C).

### Algaecide Release Performance

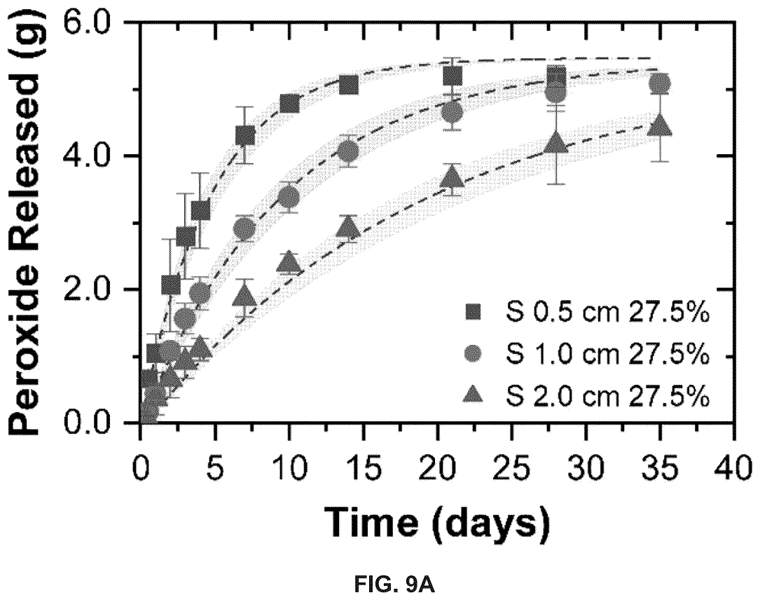

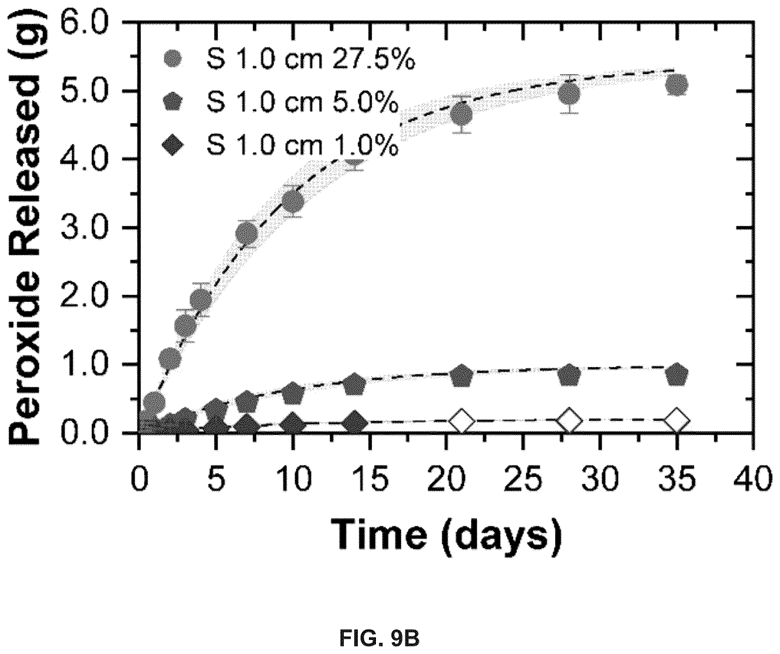

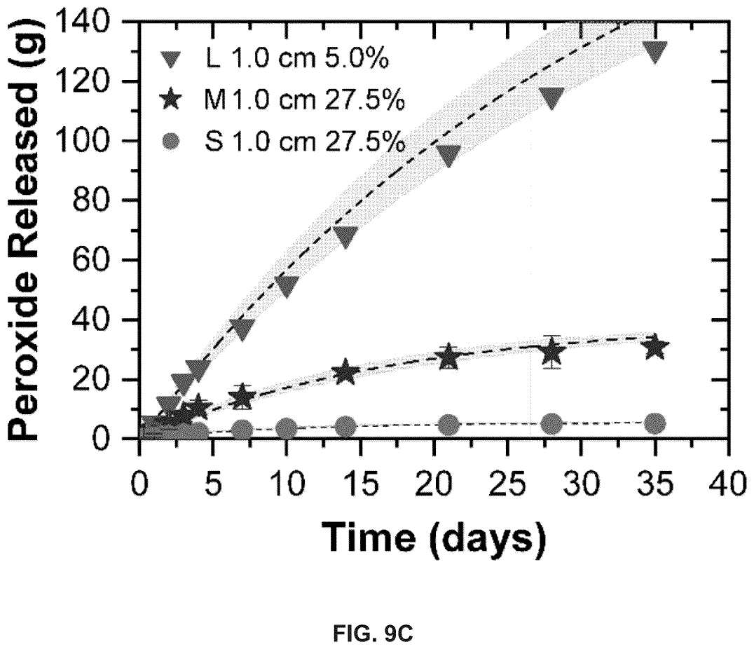

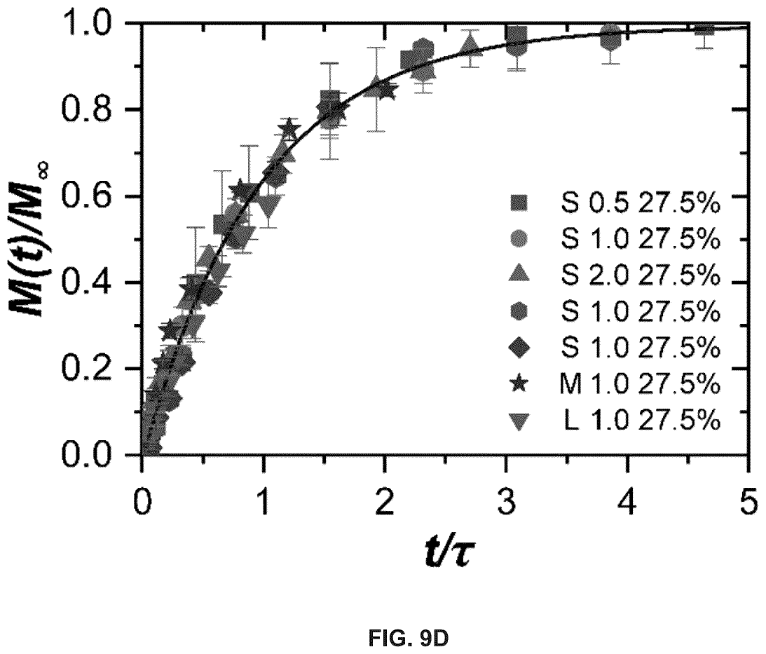

Once the buoys shown in FIGS. 6A-6C were assembled (and tested for leaks using dye-spiked water), their algaecide (H₂O₂) release profiles could be predictably tailored by varying the (1) gel disk thickness, (2) concentration of the algaecide the buoys were filled with, and (3) the buoy size (see FIGS. 9A-9C). As the thickness of the gel disks increased, the algaecide release from the small buoys (depicted in FIGS. 6A, 6C (i)) became more sustained, i.e., all the algaecide was released within ˜2 weeks when the thinnest, 0.5-cm-thick disks were used, increasing the gel disk thickness to 1 cm extended the release profile to roughly 1 month, while increasing the gel thickness to 2 cm extended the release profile to even longer time scales (FIG. 9A). This gel barrier thickness effect can be explained because as the gel became thicker, the resistance to H₂O₂ diffusion also proportionately increased.

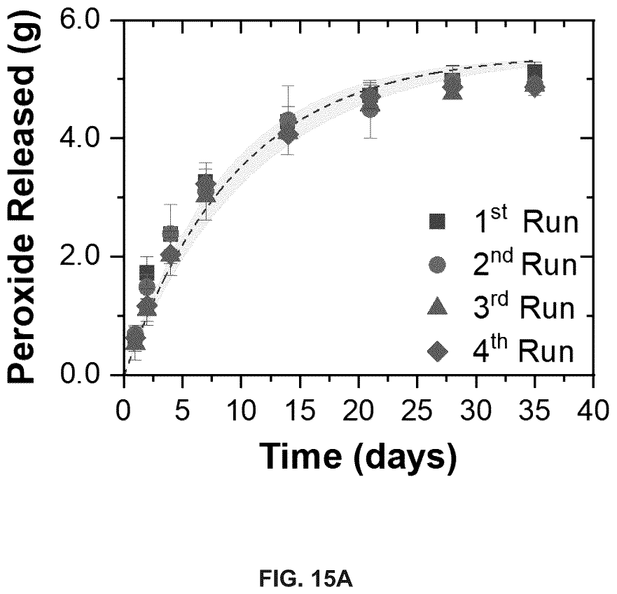

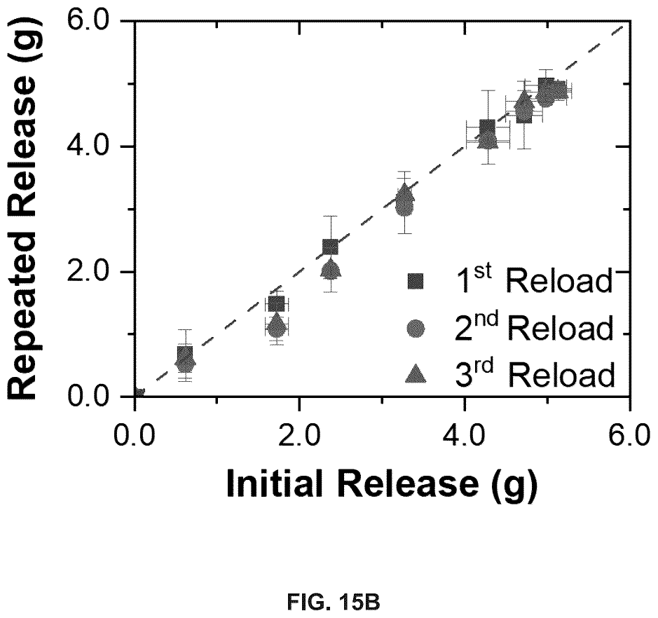

Increasing the initial H₂O₂ concentration within the buoys, on the other hand, produced a proportional increase in the cumulative mass of H₂O₂ released but did not increase the time scale over which this release occurred (FIG. 9B). Moreover, as will be shown more clearly later, this initial algaecide loading did not affect the shape of the release profile curves, and the amount of H₂O₂ released at every time point was directly proportional to its initial loading (e.g., after 14 days, the buoys loaded with 5 wt % H₂O₂ released 5.3× the algaecide released by those loaded with 1 wt % H₂O₂, and buoys loaded with undiluted Oxymycin™ P5, whose H₂O₂ content was 5.5× that of the 5 wt % H₂O₂ solutions, released 5.7× the algaecide released by those loaded with 5 wt % H₂O₂). Likewise, the H₂O₂ mass released increased with the size of the device (FIG. 9C), as larger devices (as shown in FIG. 6C) provide a larger gel arca through which the algaecide can be released. Importantly, the buoys were also reloadable. When, upon releasing full-strength Oxymycin™ P5 for 35 d, the small buoys (equipped with 1-cm-thick gels) were reloaded with algaecide, algaecide release remained essentially unchanged over four release cycles (FIGS. 15A-15B). This repeatable sustained release performance demonstrates the reusability of these devices, including their gel disk inserts (which, though they can be periodically replaced) can be reused for multiple algaecide loading/release cycles.

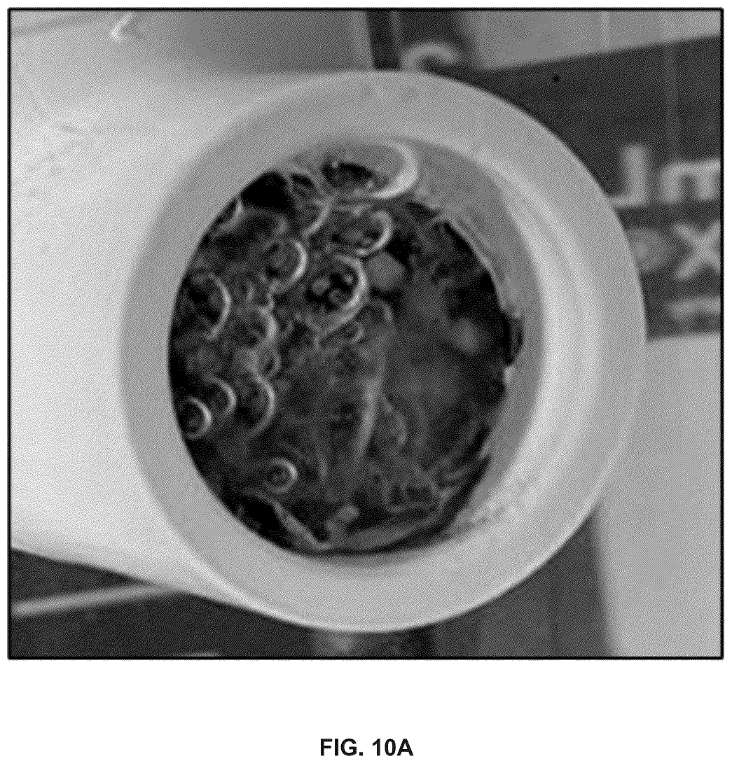

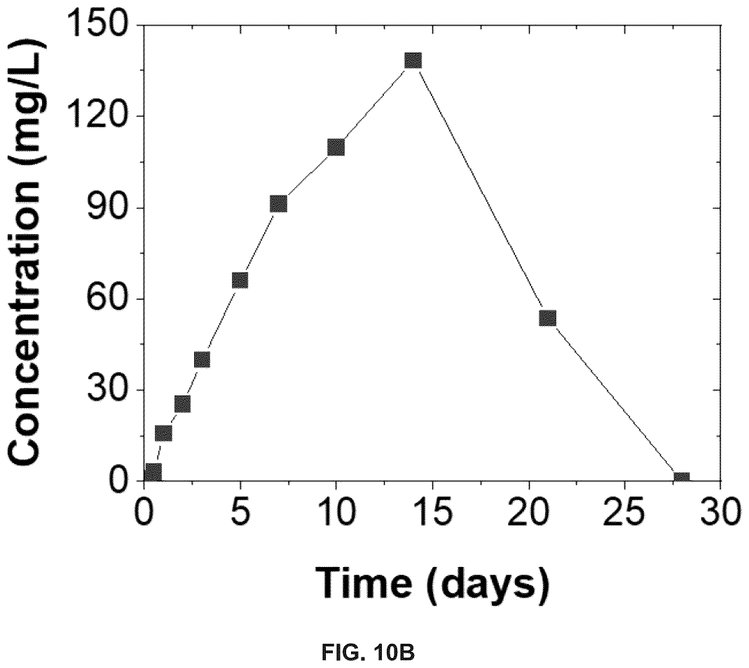

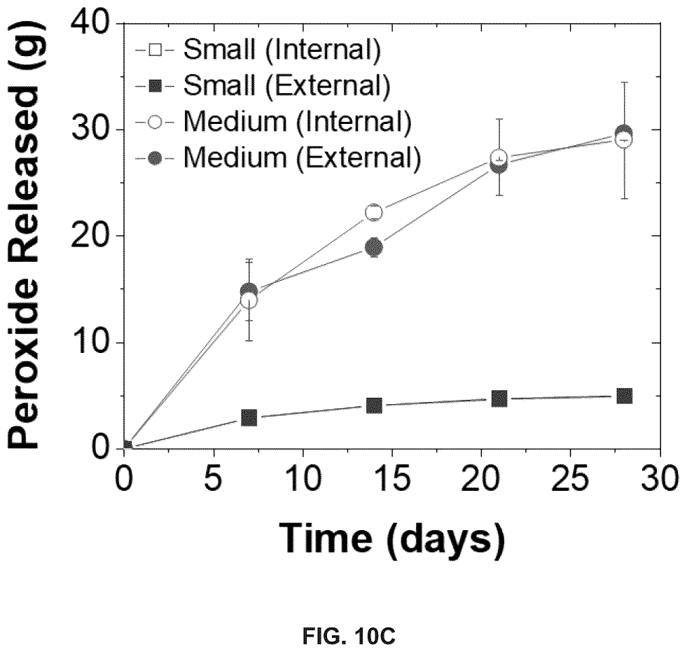

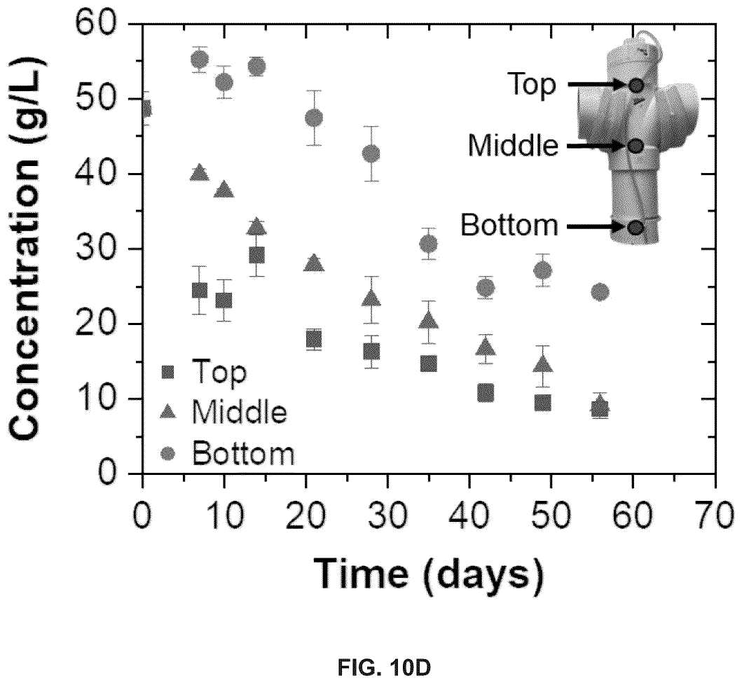

A complication that occurred in some of the experiments—particularly those performed at lower initial H₂O₂, concentrations—was microbial growth, which started at the external surface of the mesh-covered gel disks, after 15-21 days when the small buoys loaded with 1 wt % H₂O₂ were used and after ≥36 days when the large buoys loaded with 5 wt % H₂O₂ were used (FIG. 10A). This growth resulted in a rapid H₂O₂ consumption (FIG. 10B) and confounded the determination of the cumulative H₂O₂ release from measurements of the external H₂O₂ concentration in the release medium. To overcome this problem in the small buoys, the cumulative algaecide release was (once this microbial H₂O₂ consumption became significant) determined from the internal H₂O₂ concentrations inside the buoys (e.g., see open purple diamonds in FIG. 9B). For the small and medium-sized buoys, the release profile determination based on the internal H₂O₂ concentrations (though more difficult to perform) generates nearly identical results to those obtained through the external concentration measurements (see FIG. 10C). For the large buoys, however, at least in the absence of internal agitation, significant concentration gradients develop within the buoys sec FIG. 10D), which (due to the difficulty of measuring the spatial concentration profiles within the buoys) precludes the accurate determination of the release profiles from the internal H₂O₂ concentrations within the buoys. Thus, reliable release profile data obtained for the large buoys loaded with 5 wt % H₂O₂ was limited to 35 days.

Despite these complications, each trend described in FIGS. 9A-9C can be understood and quantitatively predicted by modeling each buoy as a reservoir device, whose contents are (though this is an imperfect assumption) assumed to be maintained at a spatially uniform concentration. For such a device, the release rate at which the internal payload (i.e., algaecide) concentration drops with time can (assuming that its concentration in the receiving solution remains much lower than its internal concentration) be mathematically modeled as:

$${V}_{A} \frac{{dC}_{A}}{dt} = - {K}_{m} {aC}_{A} \qquad ( 2 )$$

where V_{A} is the internal buoy/reservoir volume, C_{A} is the internal algaecide concentration, Kₘ is the mass transfer coefficient, a is the interfacial area between the algaecide-releasing portion of the device and the surrounding medium, and t is time. The solution to this differential equation yields the exponential function:

$${C}_{A} ( t ) = {C}_{A , i} exp \{ - \frac{{K}_{m} a}{{V}_{A}} ( t - {t}_{l} ) \} \qquad ( 3 )$$

where C_{A,i} is the initial algaecide concentration within the buoy and tₗ is the lag time (i.e., the time required for the diffusing algaecide to cross the gel barrier and begin releasing). From this equation, the fraction of the algaecide released by time t can be predicted as:

$$M ( t ) / {M}_{∞} = 1 - exp \{ - \frac{{K}_{m} a}{{V}_{A}} ( t - {t}_{l} ) \} \qquad ( 4 )$$

In contrast, at very short times where t<tₗ, C_{A}(t) and M(t)/M_{∞} are estimated to remain constant at C_{A,i}. and 0, respectively. Assuming that (1) the time required for C_{A}(t) to appreciably change is much longer than that required for the payload concentration within the device wall to roughly reach steady state, (2) the device wall (i.e., the gel layer) provides the dominant resistance to the release process, and (3) the mass transfer resistance due to the mesh holding the gel disks in place can also be neglected, Km for a flat, slab-like wall (like the gel disks) can be approximated as:

$${K}_{m} = \frac{DH}{L} \qquad ( 5 )$$

where D is the payload diffusivity within the device wall (i.e., the gel disks), H is its distribution coefficient into the gel (reported above), and L is the gel thickness. Thus, the model algaecide release profile can be related to the properties (D, H, and L) of the gel disks, as well as gel area-to-internal volume ratio (a/V_{A}):

$$M ( t ) / {M}_{∞} = 1 - exp \{ - ( t - {t}_{l} ) / τ \} \qquad ( 6 )$$

where t is the characteristic release process time, estimated as:

$$τ = \frac{{V}_{A} L}{DHa} \qquad ( 7 )$$

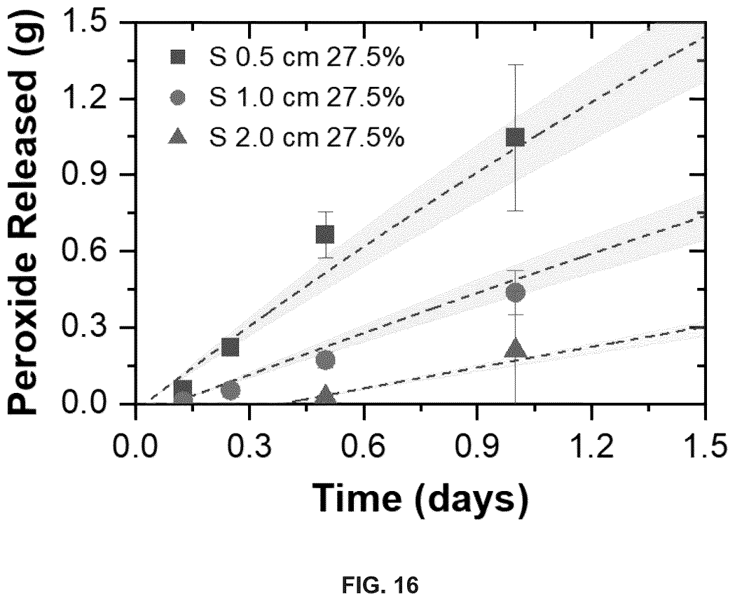

Finally, tₗ (which is evident when the release profiles are rescaled to focus on the first day of the release process; FIG. 16) depends on the characteristic diffusion time required for the pseudo-steady-state algaecide concentration profile within a gel slab of thickness L to be achieved (assuming a roughly constant C_{A}). This characteristic diffusion time, t_{D}, is given by:

$${t}_{D} = \frac{{L}^{2}}{2 D} \qquad ( 8 )$$

Since the time required for the algaecide to reach from the inner gel surface to its outer surface (at which point it will start releasing) does not require steady-state to be fully achieved, however, tₗ is shorter than t_{D}, and can be estimated as:

$${t}_{l} \approx \frac{{t}_{D}}{3} \qquad ( 9 )$$

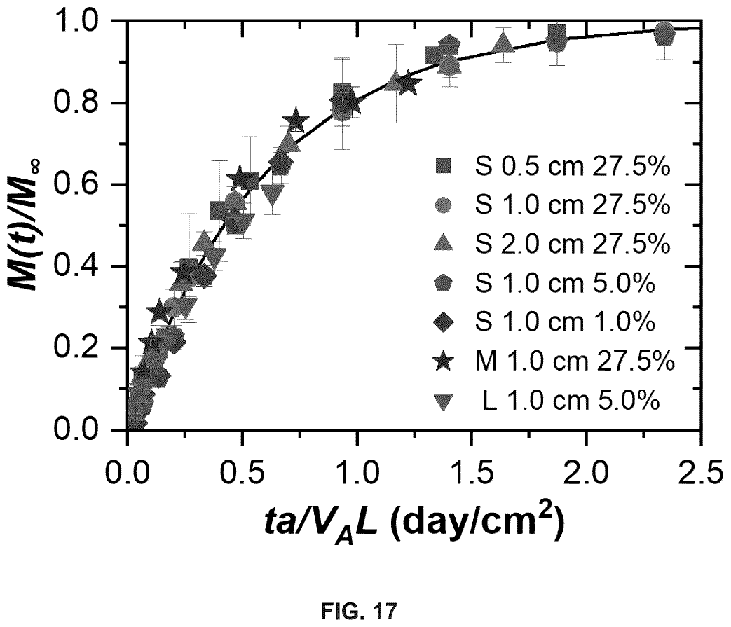

The resulting model M(t)/M_{∞} vs. t equation (when Eq. 6 is used with 1.5-2.0×10⁻⁵ cm²/s literature values for H₂O₂ D in water and model t_{D}, tₗ, and τ-values in Table 1) agrees excellently with the experimental release profiles in FIGS. 9A-9C, as is clear from the agreement between the experimental data points in these plots and the shaded regions (which correspond to model predictions based on the H measured above and the literature D-value range and, in cases where this region is thin, overlaps with the solid curves). Indeed, when these release profiles are scaled to the initial H₂O₂ concentrations (C_{A,i}), and theoretical characteristic process time (predicted via Eq. 7) and plotted as M(t)/M_{∞} vs. t/τ, all the release profiles collapse onto a single master curve that is consistent with Eq. 6 (FIG. 9D). This scaling was achieved by first constructing a similar M(t)/M_{∞} vs. at/V_{A}L plot (FIG. 17), which collapses all the release data into a single master curve but leaves the scaled time axis in a dimensional form. This plot was then used to determine an empirical DH product (based on all the release profiles in FIGS. 9A-9C) that was used to (following Eq. 7) covert the at/V_{A}L-axis into at t/τone. Specifically, the DH was determined by fitting all data sets in FIG. 17 to Eq. 6 (using DH as the sole adjustable parameter). This curve fitting yielded a DH of (1.90±0.04)×10⁻⁵ cm²/s, which corresponded to a fitted D-value of (1.76±0.10)×10⁻⁵ cm²/s, aligned perfectly with the literature D range, and produced a remarkable agreement between the fitted model master curve and the experimental data (FIG. 9D and FIG. 17). This agreement indicates that the release profiles can be predictably tailored by varying the gel disk dimensions and properties, and the volume and initial algaecide concentration within the buoys.

TABLE 1
Model t_{D}, tₗ, and τ-values and τ/t_{D} ratios for each tested buoy design (calculated
based on literature 1.5-2.0 × 10⁻⁵ cm²/s D-values).

| Buoy | | | | | | | |
|---|---|---|---|---|---|---|---|
| Size | a (cm²) | V (cm³) | L (cm) | t_{D} (s) | tₗ (s) | τ (s) | τ/t_{D} ^{(a)} |
| Small | 1.27 | 20 | 0.5 | (7.3 ± 1.0) × 10³ | (2.4 ± 0.3) × 10³ | (4.3 ± 0.6) × 10⁵ | 58 |
| Small | 1.27 | 20 | 1.0 | (2.9 ± 0.4) × 10⁴ | (9.7 ± 1.4) × 10³ | (8.5 ± 1.2) × 10⁵ | 29 |
| Small | 1.27 | 20 | 2.0 | (1.2 ± 0.2) × 10⁵ | (3.9 ± 0.6) × 10⁴ | (1.7 ± 0.2) × 10⁶ | 15 |
| Medium | 10.1 | 145 | 1.0 | (2.9 ± 0.4) × 10⁴ | (9.7 ± 1.4) × 10³ | (7.7 ± 1.1) × 10⁵ | 27 |
| Large | 162 | 4500 | 1.0 | (2.9 ± 0.4) × 10⁴ | (9.7 ± 1.4) × 10³ | (1.5 ± 0.2) × 10⁶ | 51 |

^{(a)}Because τ and t_{D} have the same inverse dependence on D, τ/t_{D} is independent of D, which eliminates the uncertainty stemming from the variation in the literature D-values from this calculation.

As a final step in analyzing these release profiles, the findings were used to critically examine the assumptions of the above model analysis when applied to the algaecide-releasing buoys. The assumption that the time required to establish a steady algaecide concentration within the gel disks is much shorter than the time required for the internal algaecide concentration within the buoys to appreciably change was first evaluated. This can be readily done by combining Eqs. 7 and 8 to calculate the t/t_{D}-ratio:

$$τ / {t}_{D} = \frac{2 {V}_{A}}{aLH} \qquad ( 10 )$$

For all tested design configurations, t/t_{D} exceeds 10 (Table 1). Thus, though (as predicted by Eq. 10) the above assumption would break down in the limit of high L, a/V_{A}-ratio, and H, it is satisfied in the range of a, L, H, and V_{A} combinations examined in these examples. In other words, the calculated t/t_{D}-ratios confirm that a steady-state concentration profile within the gels was established considerably faster than the time required for the internal algaecide concentration to significantly change.

The second assumption, that the gel disks provide the dominant resistance to the release process, can be tested using the Biot number (Bi), which quantifies the ratio of the solid barrier-phase resistance to solute transport to that of adjacent fluid phases as:

$$Bi = \frac{{kL}_{c}}{DH} \qquad ( 11 )$$

where k is the convective mass transfer coefficient in the surrounding fluid and L_{c} is the characteristic length characterizing the thickness of the solid-phase diffusion barrier. For an agitated liquid, k is expected to be ˜10⁻³ cm/s, while L_{c} for diffusion across a flat slab is equal to its thickness (L). Thus, for 0.5-2.0-cm-thick gel disks surrounded by well-stirred water (and the literature D-range described above), Bi ˜20-100 and supports the assumption of the gel providing the dominant resistance. A limitation of this Bi analysis, however, is that the k estimate it uses assumes substantial convection within the liquid. While this condition was certainly satisfied in the gently stirred release medium, convective mixing within the buoys—as indicated by the concentration nonuniformities within the large buoys (see FIG. 10D)—was significantly more limited and likely produced lower k and Bi values than indicated by the above analyses. Still, the impressive agreement between the experimental data and Eq. 6 indicates the model analysis to provide valuable design guidelines.

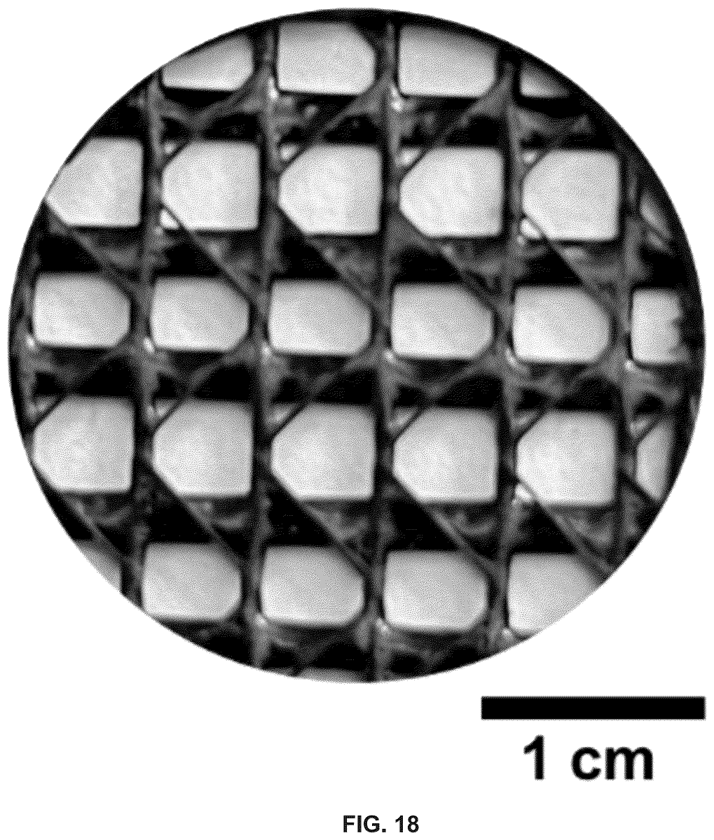

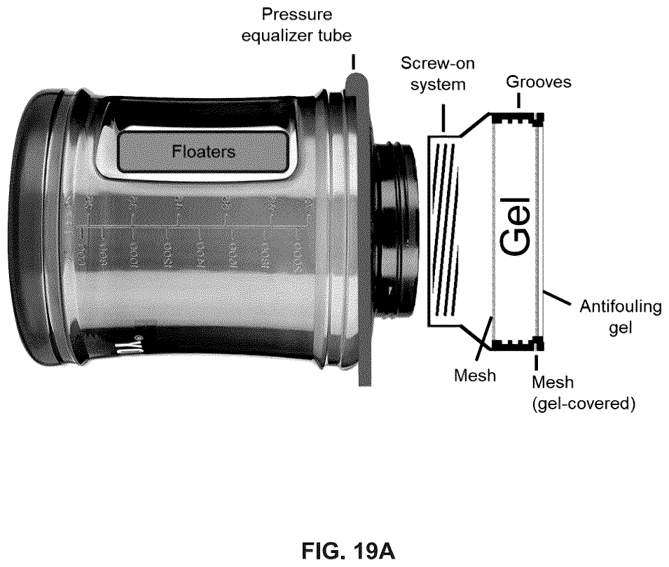

The third and final assumption is of the negligible transport resistance due to the mesh. An ImageJ software (National Institutes of Health; Bethesda, MD) analysis of digital photographs of the vinyl mesh revealed that the mesh covers 48% of the gel surface, while leaving 52% of the gel surface open (FIG. 18). To qualitatively analyze the effect of partially covering the gel surfaces with this mesh, pseudo-steady-state 2D concentration profiles and release rates out of the gel were predicted for gel disks covered (on both sides) by impermeable films with circular, variably sized openings. These covered disks served as a simplified model for diffusion across gels whose surfaces are partially insulated to diffusion by the meshes. Although this partial obstruction of the gel surface decreased the theoretical release rate, this reduction was significantly smaller than that in the exposed gel surface area. This attenuated effect on the model release rates stemmed from the nonlinearity in the concentration profiles produced by the partial obstruction of the gel surfaces, where the model algaecide concentration gradients were concentrated near the holes within the impermeable films. Following Fick's law, these focused concentration gradients caused the predicted algaecide release rate per unit of exposed gel area (i.e., the algaecide release flux) to be higher than it would have been without the partial gel obstruction, thus partially offsetting the obstruction effect. Between this offsetting effect and the corrugated mesh surface structure (FIG. 18) making it unlikely that the mesh forms a gap-free attachment to the gel with its entire surface, the seemingly imperceptible effect of the mesh on the release kinetics is explainable.

### Algicidal Activity

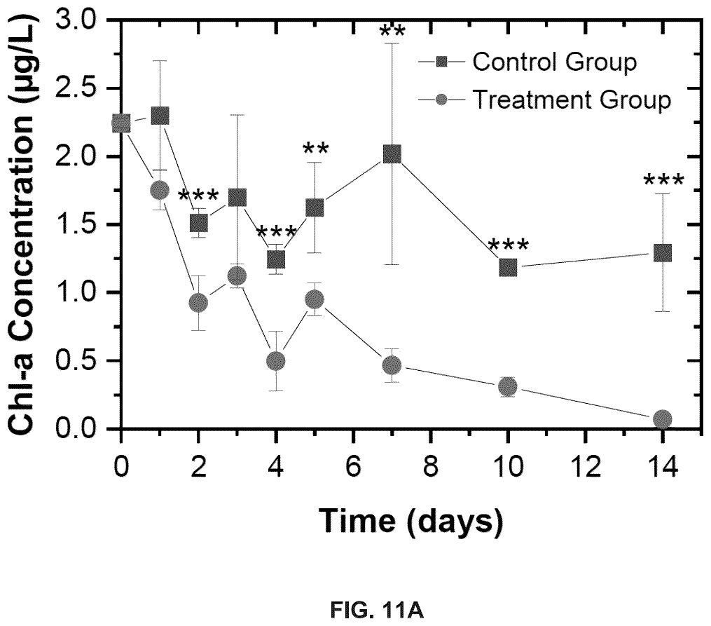

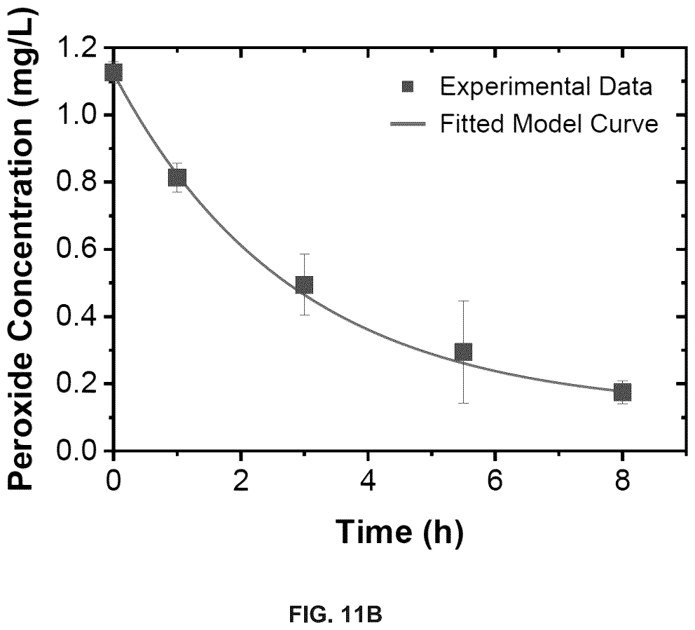

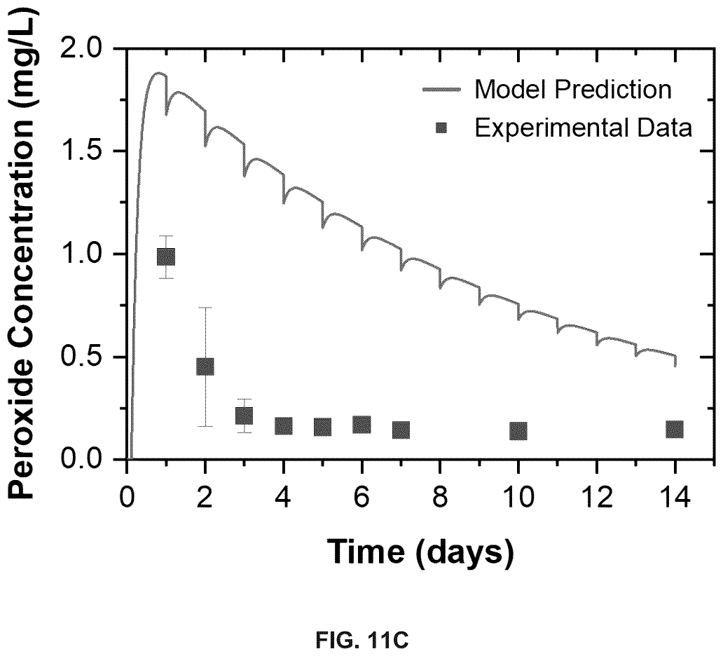

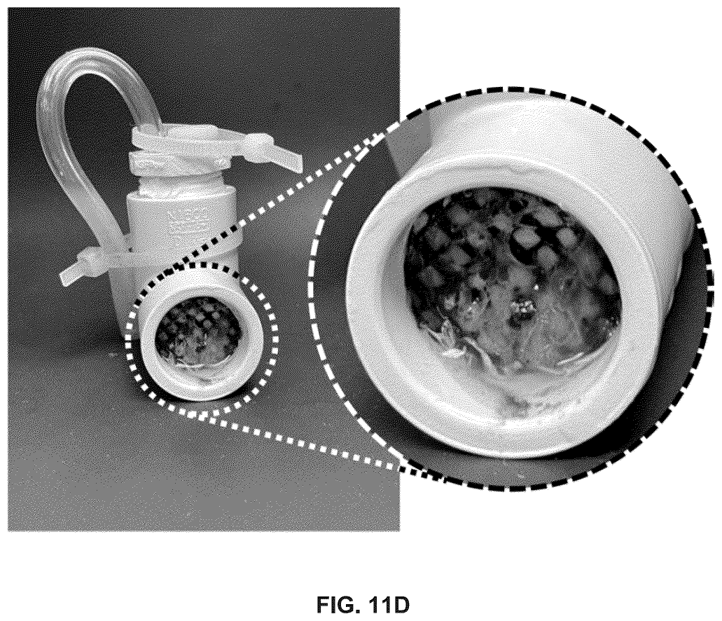

Microcosm analysis of the effect of the sustained release (performed using the smallest of the investigated devices loaded with diluted, 0.6 wt % H₂O₂-strength Oxymycin™ P5), confirmed that the sustained release from the buoys can provide a sustained, multiweek effect against CHABs (FIG. 11A). Without the sustained algaecide release, the average Chl-a concentrations (which reflected cyanobacterial concentrations) fluctuated between 1.2 and 2.3 μg/L, due to natural senescence and competitive interactions within the microbial community and, gradually decreased with time (control group in FIG. 11A). In contrast, despite the daily replenishment of 10% of the lake water, gradual Oxymycin™ P5 release from the miniature buoy produced a much sharper drop in cyanobacterial concentration (which became increasingly more pronounced with time), producing statistically significant reductions (p<0.05) in their abundance at all other than the day 1 and 3 time points and dropping the Chl-a level to 0.07 μg/L (or ˜5% of their average concentration in the control group) after 14 days (treatment group in FIG. 11A).

To predict the algaecide levels accumulating in the lake water from the buoys, the degradation kinetics of the H₂O₂ within the lake water was examined by adding a single charge of algaecide to the water and monitoring the decay in its concentration. When the H₂O₂ was introduced at a 1 mg/L initial concentration, it exhibited an exponential decay, indicating first-order degradation kinetics with an apparent reaction rate constant (kᵣ) of 0.25±0.02 s ⁻¹ (based on the fitting of a first-order exponential decay curve in FIG. 11B). Based on these degradation kinetics, the evolution in the H₂O₂ concentration within the lake water can be mathematically modeled as:

$${V}_{B} \frac{{dC}_{B}}{dt} = {K}_{m} a ( {C}_{A} - {C}_{B} ) - {k}_{r} {C}_{B} {V}_{B} \qquad ( 12 )$$

where VB is the external stirred lake water volume, C_{B} is the external algaecide concentration. Substituting expressions for Kₘ and C_{A} (from Eqs. 3, 5, and 7), this equation becomes:

$${V}_{B} \frac{{dC}_{B}}{dt} = \frac{DHa}{L} [ {C}_{A , i} exp \{ - ( t - {t}_{l} ) / τ \} - {C}_{B} ] - {k}_{r} {C}_{B} {V}_{B} \qquad ( 13 )$$

While this differential equation can be solved analytically (using the initial condition of C_{B}=0 at t≤tₗ), the daily replacement of the 10% of the lake water volume introduces a discontinuity in the concentration profile (i.e., every 24 h, C_{B} instantaneously drops by 10%). To incorporate this feature into the model prediction, Eq. 13 is solved for C_{B}(t) numerically via a custom MATLAB script. This script employs an explicit, step-by-step computational approach, akin to the Euler Method, to iteratively calculate the concentration of algaecide in the lake water over time (while accounting for the release and first-order degradation kinetics of the H₂O₂ and the daily 10% water replacement). At each step, the script updates the concentration of algaecide inside the buoy and the amount of H₂O₂ released in the beakers. The degradation rate is applied continuously, while the water replacement is modeled as a discrete event occurring every 24 h, causing a 10% reduction in the concentration of algaecide in the beakers.

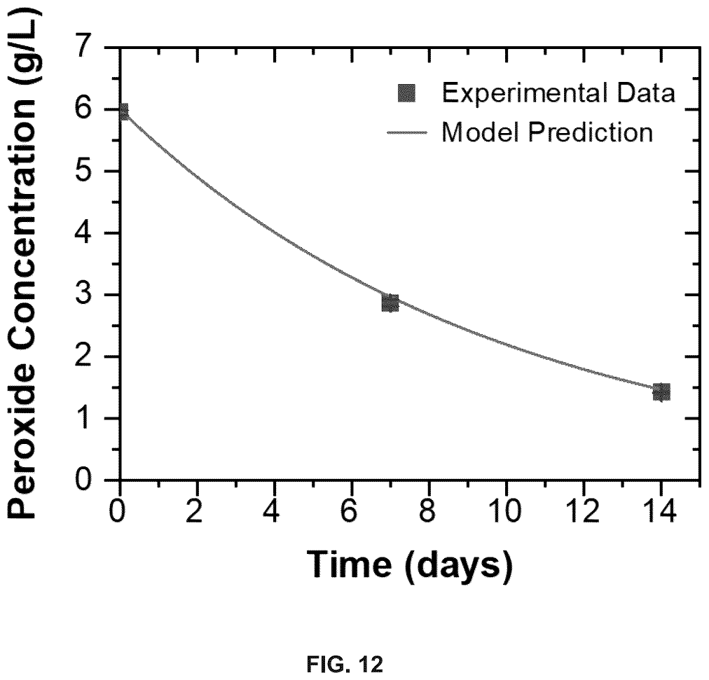

The sawtooth-patterned C_{B}(t) curve generated through this numerical approach (see solid line in FIG. 11C) predicted C_{B} to first increase and then, once the buoys became depleted of their payload and the release rate slowed down, slowly decrease with time (as the rate of algaecide degradation began to exceed its release rate). Yet, the experimentally measured C_{B}-values (squares in FIG. 11C) were—despite the algicidal effect revealed in FIG. 11A—surprisingly much lower than those predicted by the model. While the model predicted a C_{B} increase during the first day, peaking near 1.8 mg/L and then gradually decreasing over several weeks, the experimental values peaked at ˜1 mg/L after 1 day and dropped sharply to around 0.2 mg/L within just 3 days of treatment. This discrepancy occurred despite the internal algaecide concentration within the buoys (CA) decreasing at the expected rate (see FIG. 12), which indicated the discrepancy was not due to altered release kinetics. However, microbial degradation of H₂O₂ has been shown to accelerate with repeated or prolonged H₂O₂ application. Without wishing to be bound by theory, this effect has been suggested to reflect the release of internal organic matter from damaged cells. Additionally, immersion of the buoys in lake water led to fouling at the surface of the gel disks and their protecting meshes (FIG. 11D). This fouling resembled that seen at longer times in some of the controlled release experiments, where its emergence also coincided with a sharp decline in H₂O₂ concentration (sec FIGS. 10A-10B). Without being bound by theory, it is possible that (1) the gel disk-attached microbes contributed to the suppressed H₂O₂ levels by degrading it upon release and (2) the algicidal efficacy of these buoys might be further enhanced by adding an antifouling coating to the gel disk and/or protective mesh surface.

### Antifouling Coating Development

To enhance the durability and effectiveness of the buoys, we explored the development of antifouling coatings to mitigate biofouling, which may compromise performance and longevity in aquatic environments. Specifically, two antifouling treatments were tested. The first treatment used the same gel material (dual-crosslinked PAA-Al³⁺) to fully coat the outward-facing side of the mesh covering the gel discs. By completely covering the mesh, this treatment eliminated the rough surface of the mesh as a potential anchoring point for bacterial colonies, thereby minimizing biofouling on this interface. The second treatment involved the application of (PSBMA) coating on one surface of the gel discs. PSBMA was used as an amphoteric monomer that, when polymerized, formed a highly hydrophilic polymer. Being zwitterionic, PSBMA is capable of resisting protein adsorption and cell adhesion, making it an effective alternative for antifouling applications. Surfaces coated with zwitterionic polymers, such as PSBMA, have been shown to significantly reduce biofilm formation and biological fouling in aquatic environments.

To prepare the dualcrosslinked PAA-Al³⁺ coating on the mesh, custom ASA support rings (which protected the antifouling coatings during the insertion of the gel disks into the buoys) were first prepared using a 3D printer, with an outer diameter of 13.3 mm, an inner diameter of 12.7 mm, and a height of 1 mm. These rings were adhered onto the mesh, which had been previously attached to PVC rings. A thin acetate film was then affixed over the top of each ASA ring to create a sealed cavity between the acetate film and the mesh. The assembled units were then placed inside cylindrical molds, and the monomer, crosslinker, and initiator (AA, MBA, AlCl₃, and APS) mixture used to synthesize the gels was poured into each mold and allowed to polymerize, following the protocol described earlier. Once the gel was prepared, the acetate films were carefully removed, resulting in a uniform dual crosslinked PAA-Al³⁺ coating that completely covered the mesh surface.

Conversely, to synthesize the PSBMA coating, sulfobetaine methacrylate (SBMA) treatment was applied to one surface of the gel discs, prepared as described herein, to which the support ring used to coat the mesh with dual crosslinked PAA-Al³⁺ (described above) was adhered with PVC cement. An aqueous SBMA/MBA/Irgacure® 2959 monomer/crosslinker/initiator (1 M SBMA; 0.1 M MBA; 0.01 M Irgacure® 2959) solution was then evenly applied to the upper surface of the gel discs, and, to polymerize an antifouling coated layer, the discs were irradiated for 30 min with a 365 nm UV lamp (Blak-Ray B-100AP; nominal intensity=5 mW/cm²), positioned 10 cm away from their surface. To ensure a smooth and uniform SBMA coating, a second coating layer was then applied (via the same procedure) after washing/immersing the coated gels in deionized water for ˜1 h. After the second SBMA coat, the discs were immersed in deionized water for 3 days to remove any unreacted small molecules, with daily water changes, and were kept submerged in deionized water until use.

### Antifouling Coating Performance

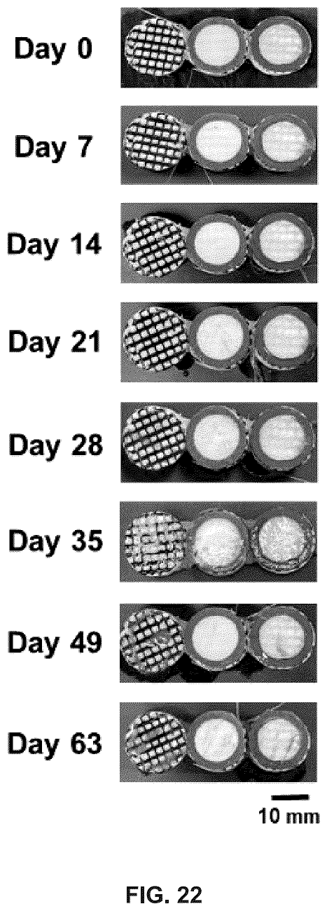

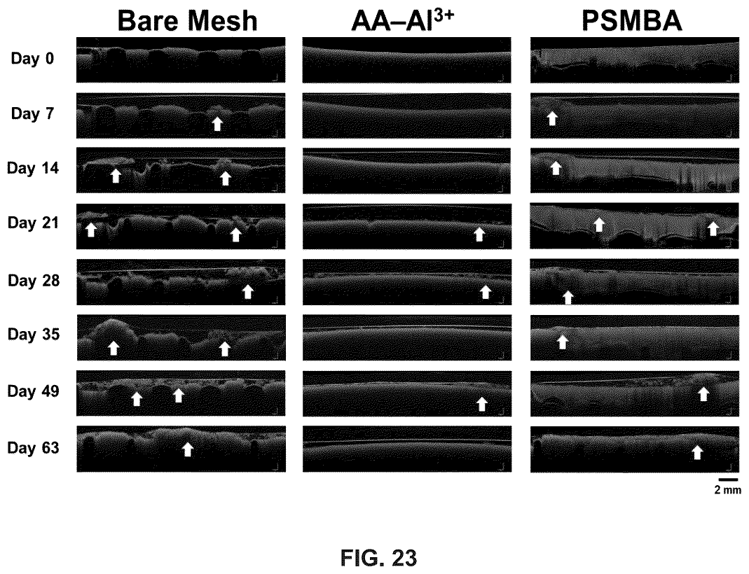

To evaluate the antifouling efficacy of different coatings, gel disc meshes were either (1) left exposed, (2) coated with dual-crosslinked PAA-Al³⁺, or (3) coated with PSBMA incubated for 63 days in water. These were then periodically imaged by both digital photography and OCT. Covering the mesh with gel layers made the outer surface of the gel disks significantly smoother, as evident from both visual observation (FIG. 22) and OCT (FIG. 23). The outer mesh (represented by the dark regions near the surface in the ‘Bare Mesh’ OCT images) produced pronounced topological variations across the surface. In contrast, the outer surfaces of the PSBMA- and dual-crosslinked PAA-Al³⁺-coated disks were both smooth, though the dual-crosslinked PAA-Al³⁺gel was much opaquer than PSMBA and—unlike the entirely visible ˜1.0-1.7-mm-thick PSMBA layer—could only be imaged to a roughly 0.6-0.8-mm depth (FIG. 23).

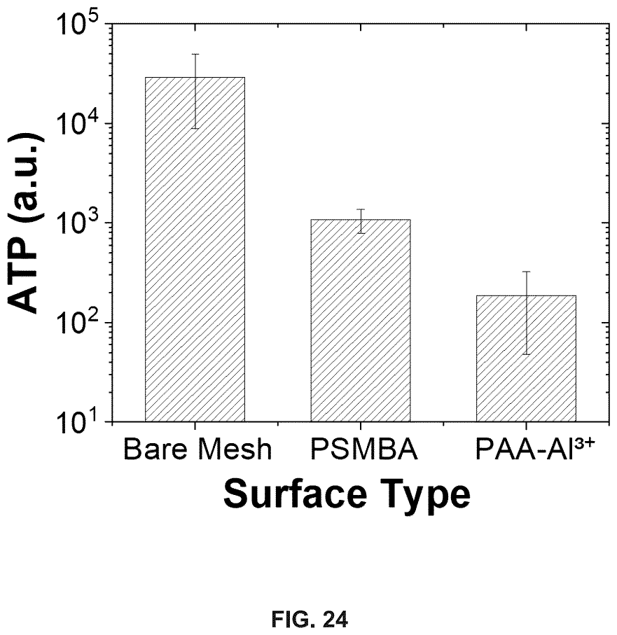

By day 7, there was initial biofilm formation on the discs with uncoated meshes, along with a single isolated spot on one PSBMA-coated discs (FIG. 22 and FIG. 23). Conversely, nothing was evident on the dual-crosslinked PAA-Al³⁺-coated surfaces. By day 21, pronounced fouling occurred on the bare mesh discs, with scattered points on the PSBMA discs and mild fouling on the PAA-Al³⁺-coated ones. This trend continued until the end of the 63-day experiment, at which point the bare mesh discs exhibited continuous biofilm coverage, the PSBMA-coated discs showed zones of surface film, and the PAA-Al³⁺-coated discs still displayed only minor surface attachment. This was evident from both imaging (FIG. 22 and FIG. 23) and ATP assay analysis (FIG. 24), which revealed microbial biofouling to be the greatest on the bare mesh and the least on gel disks with the dual-crosslinked PAA-Al³⁺-coated surfaces. Additionally, when the mesh was coated, a significant detachment of the visible surface-accumulated biomass (FIG. 22) occurred during the careful handling of the discs for OCT imaging. This behavior was most pronounced for the PAA-Al³⁺-coated surfaces and indicated that the biomass adhesion to the gel surface was weak.

### Sensing Functionality

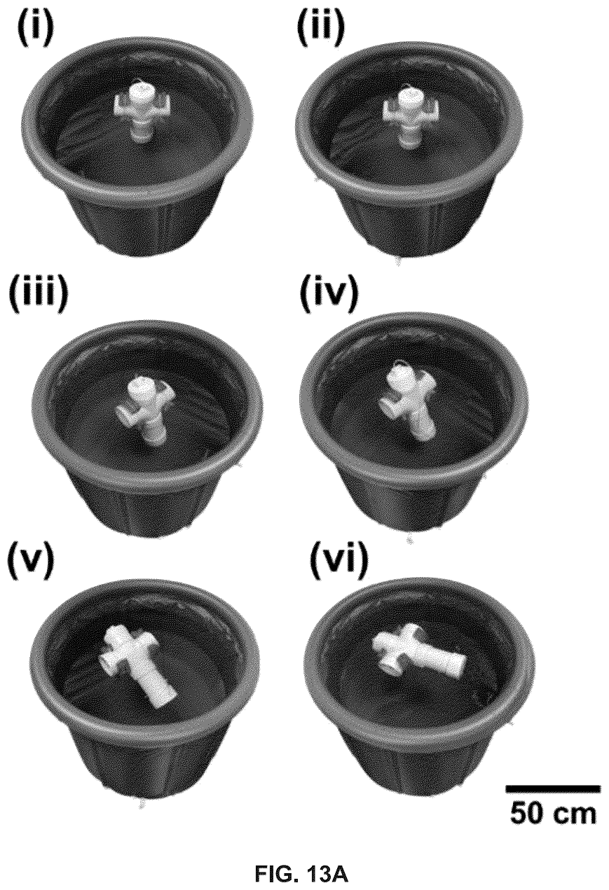

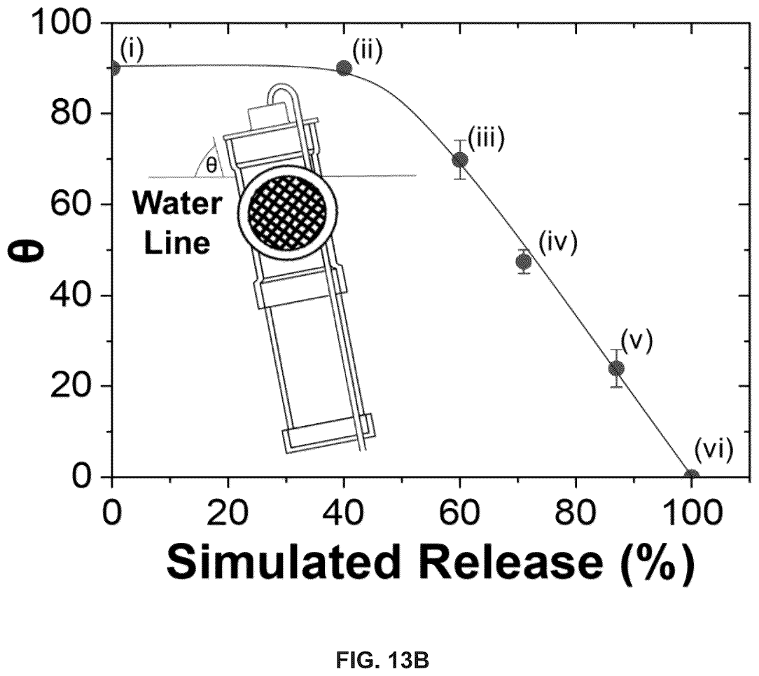

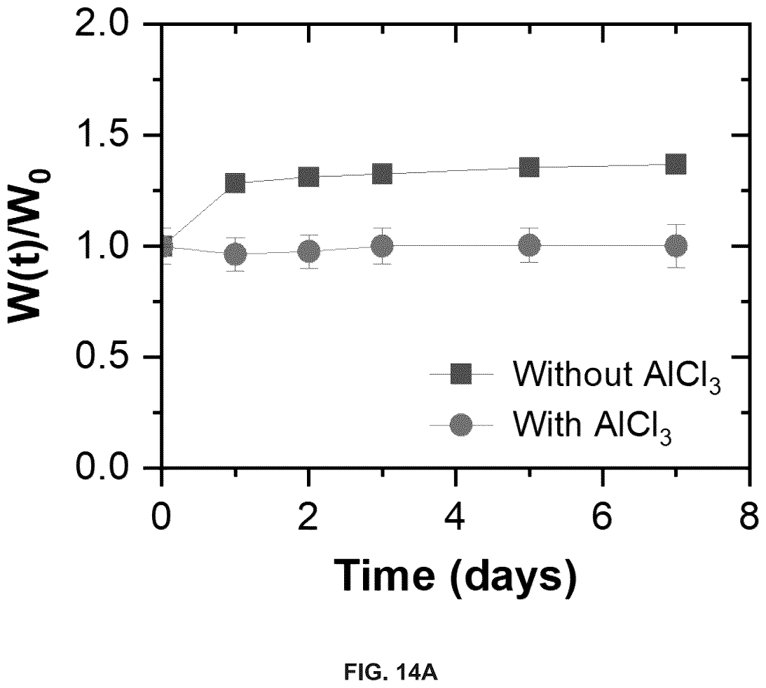

Besides their sustained release/algicidal functionality, these buoys (at least when the algaecide solution is denser than the surrounding water) can be designed to automatically alert their operators when they require refilling. This can be achieved by constructing the bottom sections of the buoys with a buoyant, foamed (rather than solid) PVC pipes (see FIG. 6B). When such buoys are filled with undiluted Oxymycin™ P5 (whose density is 1.12 g/mL), the weight of the denser algaecide solution overcomes the buoyancy of the foamed PVC pipes, and the buoys remain upright/vertical (as shown in FIGS. 13A-13B). Once the algaecide is released and the internal compartment is composed of mostly water, however, the buoyancy of the foamed PVC pipes should cause the buoys float horizontally.

To illustrate this concept, the buoys were placed and observed inside a tub. To model the effect of dense algaecide while minimizing hazards of working with large amounts of concentrated algaecide indoors, the large buoys were loaded with variably concentrated NaCl solutions (which matched the different densities of the H₂O₂ solutions at various stages in the release process). When a (16.3 wt %) NaCl solution with a density of 1.12 g/mL (which corresponds to the initial density of the Oxymycin™ P5) was loaded, the buoys remained upright (FIG. 13A (i) and FIG. 13B), indicating that the buoys should remain upright when loaded with commercial-strength algaecide. Likewise, the buoys remained upright when a 10.7 wt % NaCl solution with a density of 1.07 g/mL—corresponding to the algaecide solution density when diluted to 60% of its initial concentration (or to 40% of the algaecide being released)—was added to the buoys (FIG. 13A (ii) and FIG. 13B). This indicated that, even when a substantial amount of the algaecide is released, the buoys should maintain their vertical orientation. When the NaCl solution density was decreased further to 1.04 g/mL (corresponding to 60% of the algaecide being released), however, the buoys began changing from a vertical orientation to an inclined one, forming a 69.5±4.3° degree angle with the water line (FIG. 13A (iii) and FIG. 13B). This transition in buoy orientation continued when the NaCl solution density was decreased to 1.03 g/mL (corresponding to 70% of the algaecide being released), at which the buoys' angle with the water line dropped further to 47.3±2.6° (FIG. 13A (iv) and FIG. 13B). The buoys tilted further to 23.9±4.1° (FIG. 13A (v) and FIG. 13B) when the internal NaCl solution density was reduced to 1.02 g/mL, corresponding to 87% of the algaecide being released. And when the buoys were filled with water (without added NaCl), as would be the case when they fully release their payloads, the buoys assumed a fully horizontal configuration (FIG. 13A (vi) and FIG. 13B). Thus, buoyancy-based algaecide release sensing mechanisms can be engineered into these buoys.

### Practical Embodiments

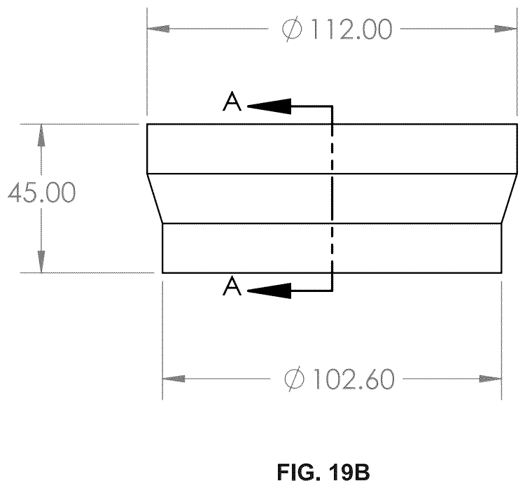

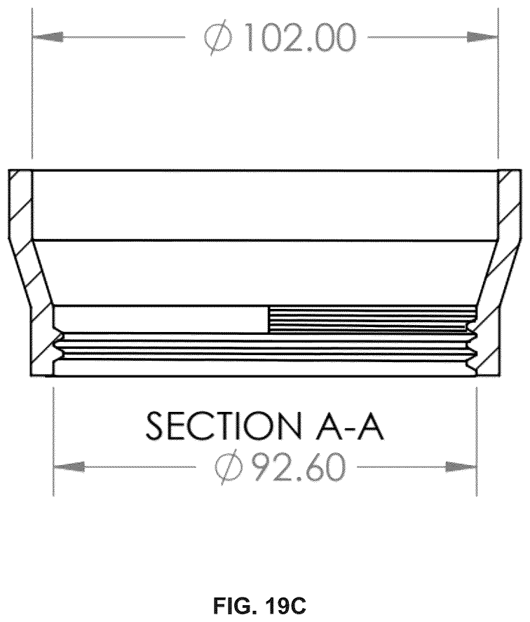

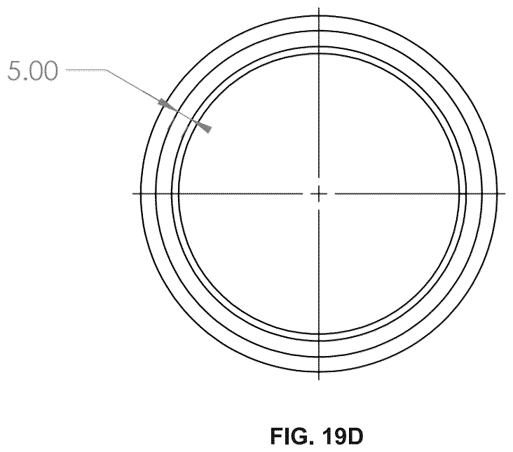

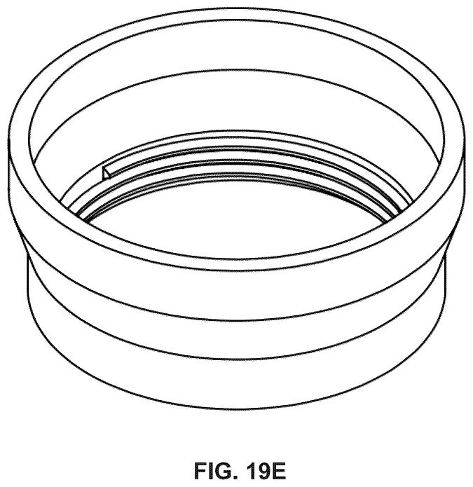

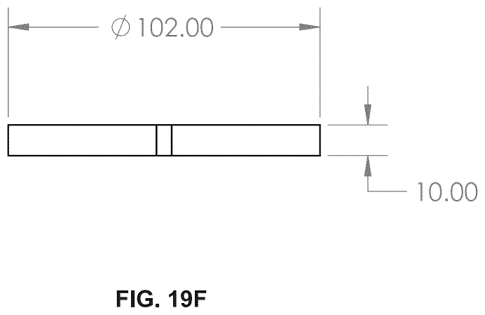

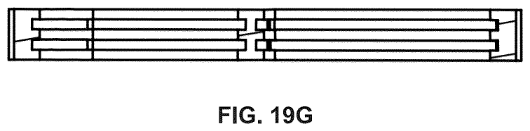

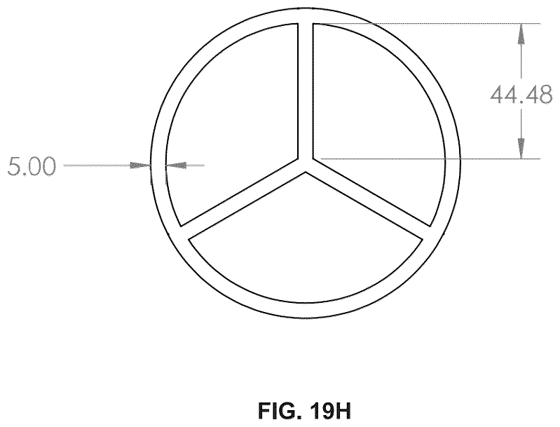

In alternate embodiments, refillable algaecide-releasing buoys can be constructed from a bottle, jar, jug, or other carboy (any vessel in which algaecides and other water treatment chemicals may be held). This practical approach reduces the complexity and cost of buoy design by reusing packaging materials for the active compounds. The original cap of the bottle, jar, jug, or carboy is replaced with a gel-bearing cap that slowly releases active compounds when immersed in water (FIG. 19A). To demonstrate this, a gel-bearing cap replacement was 3D printed and attached to a 2.75 L plastic jug, measuring 10″ in length and 6″ in diameter.

To construct the gel-bearing cap replacements, two structural parts were designed in SolidWorks and prepared using a LulzBolt TAZ 6 filament-fed 3D printer: a coupling conical threaded adaptor (referred to herein as a coupling cone; FIG. 19B-19E) and a gel compartment with a Y-shaped bracing for mechanical stabilization of the gel barrier (FIG. 19F-19I). Both components were printed using a 2.85 mm Polymaker PolyLite ASA filament. This material of construction was chosen due to its weather resistance which is critical for long-term buoy application. The thinner end of the coupling cone featured a screw-on mechanism that attached to the jug, while the wider end accommodated the gel compartment, which was attached using a PVC cement. The gel compartment (including the Y-shaped bracing) contained two groves throughout its internal perimeter, allowing the gel compartment (which contained gel adhesion-enhancing grooves) to enhance gel attachment (FIG. 19A).

To prevent biofouling, the mesh was encased with a PAA-based gel (which has been shown to have antifouling properties). To accomplish this, the gel was prepared to extend slightly beyond the mesh by positioning the gel compartment into the coupling cone such that it was 2-mm deeper than the cone's outer rim. An acetate film was then placed over the rim to act as a temporary mold, and the polymerization reaction was carried out in situ.

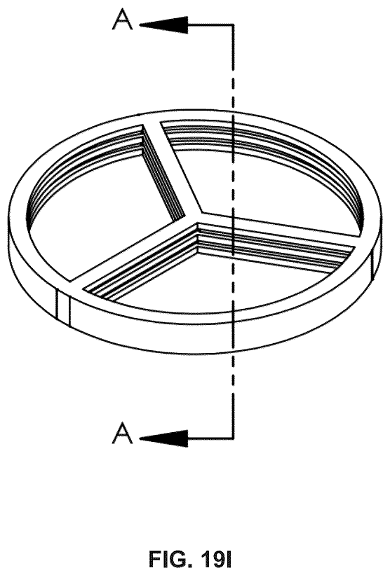

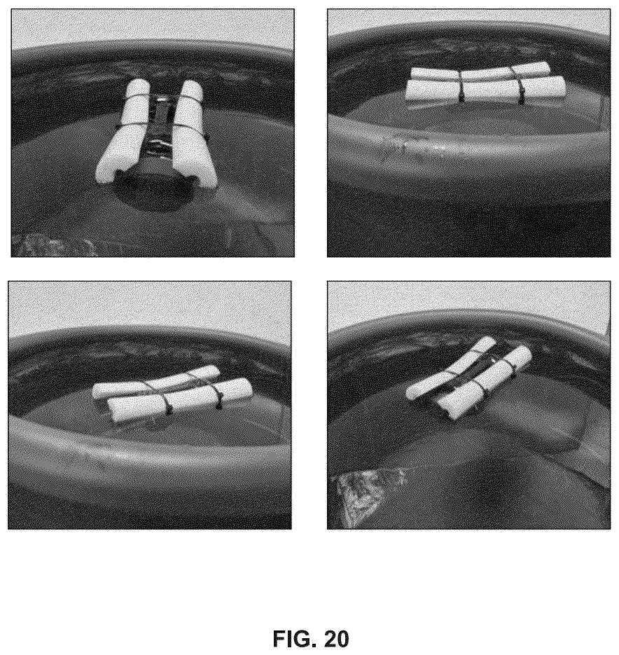

Finally, to make the structure buoyant Styrofoam strips were affixed to one side of the buoy with zip ties (FIG. 20). The buoyancy of the structure was then tested and confirmed by filling the buoy with 1.16 g/mL NaCl solution (chosen to model a high-density algaecide solution) (FIG. 20).

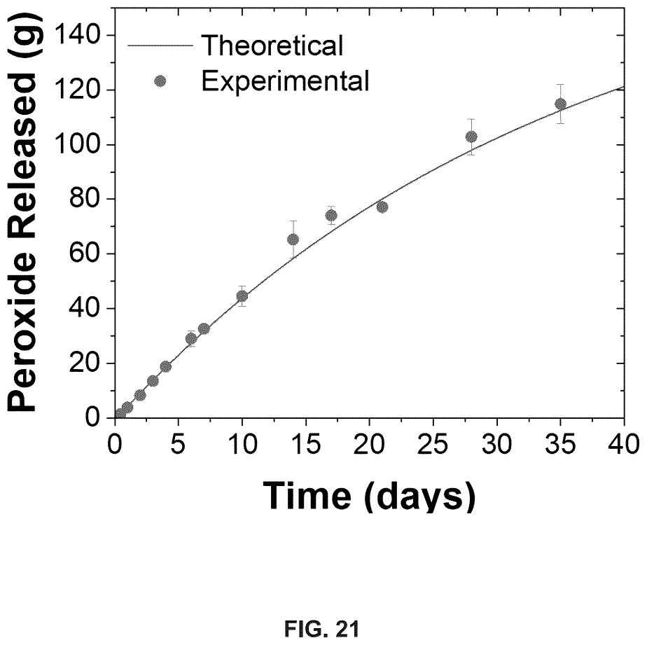

To characterize the H₂O₂ release behavior of the practical buoys, a 35-day experiment was performed in triplicate in 47-gal drums filled with 170 L of tap water. Each drum contained one buoy fitted with a 1.2-cm-thick gel layer and filled with 7 wt % H₂O₂ (diluted Oxymycin™ P5) solution and was continuously stirred with a mixer at approximately 400 rpm with FLYHERO JJ-1 electric Mixer (China) overhead stirrers. The H₂O₂ concentrations within the receiving solution were measured by UV-vis spectroscopy. The practical buoys showed no evidence of leakage after being loaded with the algaecide, and as shown in FIG. 21, produced release profiles that aligned closely with those predicted by Eqs. 6 and 7. Moreover, the amount of H₂O₂ released by the buoys after 35 days accounted for only 45% of their initial payload, confirming that this modified buoy design enabled algaecide release over periods well beyond one month.

### Underwater Deployment of Buoy

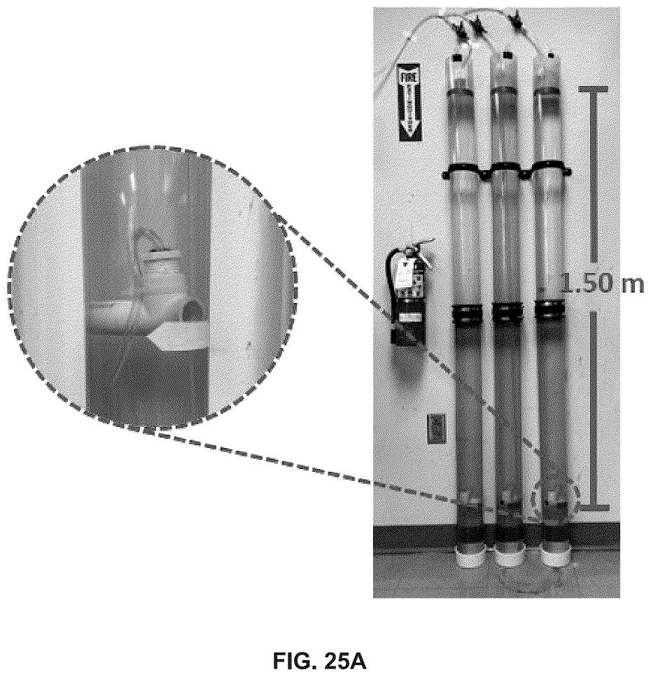

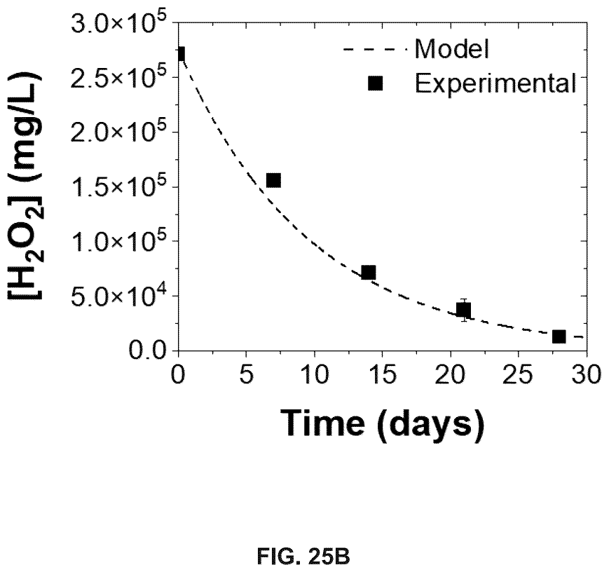

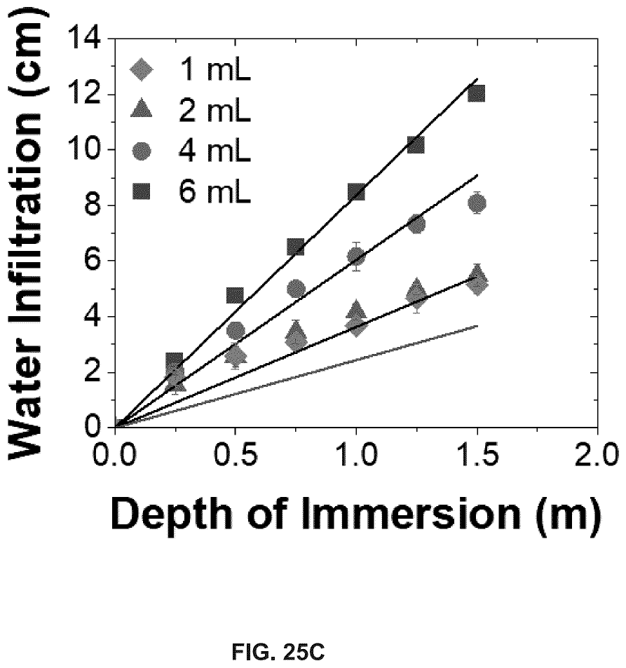

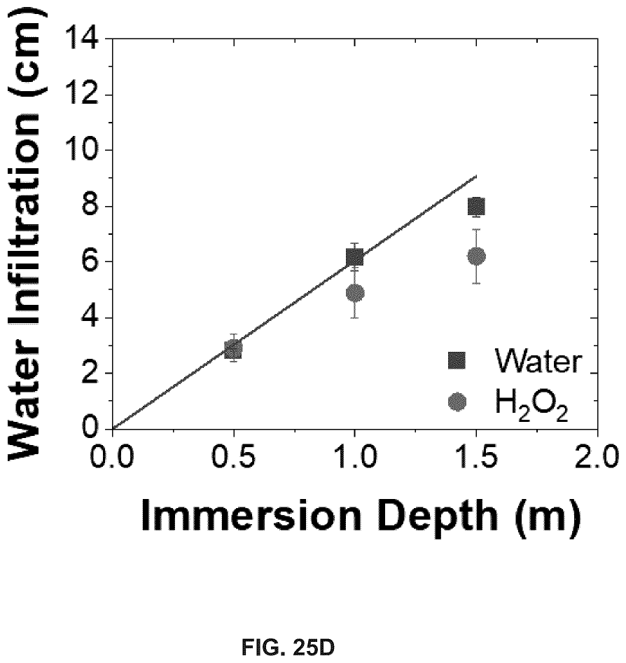

Upon immersion at a depth of 1.5 m (FIG. 25A), with gentle agitation from slow air sparging, the buoys released their payload at the same rate as at the surface. This was determined by comparing the decline in the internal H₂O₂ algaecide concentration measured weekly with model predictions (FIG. 25B). The model parameters, derived from the previous surface release experiments, showed excellent agreement with experimental data, indicating that algaecide release properties are unaffected by immersion, provided that the pressure equalizer tube is sufficiently long such that water does not infiltrate inside the buoy (due to hydrostatic pressure) upon its immersion. Moreover, we have shown that the pressure equalizer tube length requirement can be conservatively (under the assumption of negligible O₂ gas generation inside the buoys) approximated as:

$${L}_{tube} = \frac{{V}_{hs}}{{A}_{c}} [ \frac{( {P}_{0} + ρ gh ) {T}_{i}}{{P}_{0} {T}_{w}} - 1 ] \qquad ( 14 )$$

where L_{tube} is the distance of water infiltration into the pressure equalizer tube upon buoy immersion, Vₕₛ is the headspace volume within the internal buoy chamber, A_{c} is the cross-sectional area of the pressure equalizer tube (calculated based on its inner diameter), P₀ is the atmospheric pressure, Tᵢ is the initial temperature at which the buoys are kept before their immersion, T_{w} is the temperature of the water in which the buoys are immersed, ρ is the water density, g is the gravitational constant, and h is the buoy immersion depth.

To avoid water infiltration into the buoys, the pressure equalizer tube length must be designed to exceed L_{tube}, and the ability to do so suggests that the buoys may be used in both surface and underwater algaecide delivery applications. The water infiltration predicted by this model at various immersion depths is in excellent agreement with those measured at the standard 4-mL headspace used with the small buoys and the larger 6-mL headspace volume when the buoys were loaded with simple water instead of the O₂-generating H₂O₂ algaecide (red circles and grey squares in FIG. 25C). However, accuracy decreases with very small headspace volumes (green diamonds and blue triangles in FIG. 25C). Nonetheless, since O₂ evolved from slow H₂O₂ degradation counteracts hydrostatic pressure (i.e., pushes the infiltrating water back out), water infiltration into tubes of buoys loaded with H₂O₂-based algaecide is less than that into those with water (FIG. 25D). Thus, Eqn. 14 provides a conservative estimate of water infiltration distance and tube length requirement. Lastly, as an alternative to making the tube longer to enable the deployment of these buoys at greater depths, a bubble (i.e., a region of expanded inner diameter) can be added to the tube to increase the amount of water infiltration it can accommodate flooding the buoys without making the tube much longer.

### Conclusions

Reusable buoy-like devices for the sustained release of algaecides have been designed and analyzed. These buoys enable release of water-soluble algaecides over time scales that exceed 1 month and can be predictably adjusted by varying the surface area and thickness of the gel-based algaecide diffusion barriers (through which the algaecide is released), as well as their internal algaecide solution volume. Moreover, the algaecide dosing can be tailored by varying the initial algaecide concentration inside the buoys and, besides their sustained release functionality, these buoys can be: (1) immobilized/localized to release the algaecides at their target application sites (e.g., near the surface or the shore), (2) reloaded and reused once they release their active contents, and (3) designed to flip upon releasing their payloads, to alert their users that the buoys should be reloaded. Employment of a dual-crosslinked PAA-Al³⁺ or PSBMA coating may be utilized to control biofouling on these devices, but even without such coatings, a microcosm algacidal activity analysis shows that these devices provide an algacidal effect over the full duration of the 2-week experiment, even increasing in its intensity over time. Collectively, these findings indicate that such reusable, algaecide-releasing buoys can be used to overcome challenges in achieving sustained and targeted algacidal effects in lakes, ponds, and reservoirs, and can minimize the need for repeated and costly algaecide treatment. This sustained release technology can also be extended to applications beyond algal bloom control, such as pest control in rice fields, or sustained disinfection.

Certain embodiments of the devices, compositions, and methods disclosed herein are defined in the above examples. It should be understood that these examples, while indicating particular embodiments of the invention, are given by way of illustration only. From the above discussion and these examples, one skilled in the art can ascertain the essential characteristics of this disclosure, and without departing from the spirit and scope thereof, can make various changes and modifications to adapt the devices, compositions, and methods described herein to various usages and conditions. Various changes may be made and equivalents may be substituted for elements thereof without departing from the essential scope of the disclosure. In addition, many modifications may be made to adapt a particular situation or material to the teachings of the disclosure without departing from the essential scope thereof.

What is claimed is:

1. A buoy for sustained release of a payload, the buoy comprising a buoyant structure including a hydrogel structure, a reservoir, and an opening, wherein the reservoir is configured to hold the payload that can reach the opening by diffusing through the hydrogel structure.

2. The buoy of claim 1, wherein the hydrogel structure comprises a gel assembly including a ring housing a hydrogel held in place by a mesh, a perforated film, a porous film, a perforated sheet, or a porous sheet.

3. The buoy of claim 1, wherein the reservoir is constructed from a carboy.

4. The buoy of claim 1, wherein the hydrogel structure comprises a gel-bearing cap replacement comprising a coupling cone attached to the reservoir and a gel compartment configured to house a hydrogel.

5. The buoy of claim 4, wherein the gel-bearing cap replacement does not have a circular cross section.

6. The buoy of claim 1, wherein the hydrogel structure comprises a hydrogel; and
wherein the hydrogel comprises a polyacrylic acid.

7. The buoy of claim 1, wherein the hydrogel structure comprises a hydrogel; and
wherein the hydrogel is formed from a free-radical polymerization of an aqueous solution containing acrylic acid (AA), N,N′-methylenebisacrylamide (MBA), AlCl₃, and ammonium persulfate (APS).

8. The buoy of claim 1, wherein the hydrogel structure comprises a hydrogel; and
wherein the hydrogel is in a form of a cylindrical disk.

9. The buoy of claim 1, further comprising a floatation aid on the reservoir to aid in buoyancy.

10. The buoy of claim 1, further comprising a pressure equalizer tube configured to vent a gas from the reservoir to an external environment.

11. The buoy of claim 1, wherein the reservoir is configured to hold the payload that can only reach the opening by diffusing through the hydrogel structure.

12. A buoy for delivering a payload, the buoy comprising:
a buoyant structure comprising one or more enclosure components in water-tight communication, the enclosure components including a first arm and a central member defining a reservoir; and
a gel assembly disposed within the first arm, wherein the gel assembly comprises a hydrogel;
wherein the payload within the reservoir is capable of exiting the buoy upon diffusion of the payload through the hydrogel.

13. The buoy of claim 12, wherein the gel assembly includes a mesh configured to retain the hydrogel in position in the gel assembly.

14. The buoy of claim 12, further comprising a second arm in water-tight communication with the central member, the second arm comprising a second gel assembly.

15. The buoy of claim 12, further comprising a third arm in water-tight communication with the central member, wherein the reservoir extends into the third arm.

16. The buoy of claim 15, wherein the third arm is configured to be disposed below a water level of an aqueous environment when the reservoir contains the payload having a density greater than water, and wherein the third arm is configured to float at the water level when the reservoir is substantially free of the payload.

17. The buoy of claim 12, wherein the first arm defines a first exit, and the reservoir is configured to hold the payload which can only pass through the first exit by diffusing through the hydrogel.

18. The buoy of claim 12, further comprising a bracing structure within the first arm, the bracing structure being configured to keep the gel assembly in place and protect the gel assembly from contact by physical objects entering the first arm from an aqueous environment.

19. The buoy of claim 12, wherein the hydrogel is formed from a free-radical polymerization of an aqueous solution containing acrylic acid (AA), N,N′-methylenebisacrylamide (MBA), AlCl₃, and ammonium persulfate (APS).

20. A hydrogel composition comprising a hydrogel formed from a free-radical polymerization of an aqueous solution containing about 1 M acrylic acid (AA), about 4 wt % N,N′-methylenebisacrylamide (MBA), about 1 wt % AlCl₃, and about 0.4 wt % ammonium persulfate (APS).
